(19) United States
(12) Patent Application Publication
(10) Pub. No.: US 2008/0288618 A1
(43) Pub. Date: Nov. 20, 2008

(54) Networked Device Control Architecture

(76) Inventors: Arieh Vardi, Tel-Aviv (IL); Eran Gample, Tel-Aviv (IL); Timothy Sixtus, Upper Holland, PA (US); Keira Guip Sixtus, Woodstock, NY (US); Oded Vardi, Tel-Aviv (IL)

Correspondence Address: DANIEL J SWIRSKY, 55 REUVEN ST., BEIT SHEMESH, 99544, IL

(21) Appl. No.: 11/718,072

(22) PCT Filed: Oct. 27, 2005
(86) PCT No.: PCT/IL05/01124

§ 371 Date: Jun. 25, 2008

Related U.S. Application Data
(60) Provisional application No. 60/622,008, filed on Oct. 27, 2004.

(51) Int. Cl. G06F 15/173

(52) U.S. Cl. 709/223

(57) ABSTRACT

A networked device control system including a plurality of networked device controllers operative to implement a protocol of automatic device discovery and control, at least one non-protocol-compliant device connected to any of the controllers and not configured for use with the protocol prior to being connected to the controller, and a management unit operative to generate any of an interface and a control element associated with any of the devices, establish a proxy configured for use with the protocol and operative to control the non-protocol-compliant device, and configure any of the controllers with the interface and control element generated for the device connected to the controller.

### CROSS-REFERENCE TO RELATED APPLICATIONS

This application is related to and claims priority from U.S. Provisional Patent Application No. 60/622,008 to Vardi et al., entitled “Networking Architecture,” filed Oct. 27, 2004, and incorporated herein by reference in its entirety.

### FIELD OF THE INVENTION

The present invention relates to control systems in general, and more particularly to control systems for networked devices.

### BACKGROUND OF THE INVENTION

Systems that control multiple devices and appliances, such as home automation systems, typically provide limited interoperability between devices and appliances from different manufacturers and require custom programming for their integration into the control system. Such system often employ proprietary protocols rather than industry standard protocols and require physical in-wall wiring to connect devices and appliances to a central processor. This makes an installation in existing environments costly and difficult.

### SUMMARY OF THE INVENTION

The present invention provides an architecture for controlling multiple devices and appliances in an environment, such as the home, that allows for rapid installation, easy setup, and maintenance. The present invention employs industry-standard protocols, such as TCP/IP and UPnP™, offers wireless connectivity, and a distributed system for scalability, employing multiple controllers that may each function independently. The present invention also provides for integration and bridging between network-ready devices and non-network ready devices, such as where non-UPnP™ appliances are integrated into a UPnP™-based home network.

In one aspect of the present invention a networked device control system is provided including a plurality of networked device controllers operative to implement a protocol of automatic device discovery and control, at least one non-protocol-compliant device connected to any of the controllers and not configured for use with the protocol prior to being connected to the controller, and a management unit operative to generate any of an interface and a control element associated with any of the devices, establish a proxy configured for use with the protocol and operative to control the non-protocol-compliant device, and configure any of the controllers with the interface and control element generated for the device connected to the controller.

In another aspect of the present invention the management unit is operative to configure any of the controllers to which the non-protocol-compliant device is attached to act as the proxy.

In another aspect of the present invention the proxy is operative to translate a protocol-compliant command into a command for controlling the non-protocol-compliant device, and send the translated command to the non-protocol-compliant device.

In another aspect of the present invention the protocol is the UPnP™ protocol.

In another aspect of the present invention a networked device control system is provided including a plurality of networked device controllers operative to implement a protocol of automatic device discovery and control, at least one protocol-compliant device connected to any of the controllers and configured for use with the protocol prior to being connected to the controller, at least one non-protocol-compliant device connected to any of the controllers and not configured for use with the protocol prior to being connected to the controller, and a management unit operative to generate any of an interface and a control element associated with any of the devices, establish a proxy configured for use with the protocol and operative to control the non-protocol-compliant device, and configure any of the controllers with the interface and control element generated for the device connected to the controller.

In another aspect of the present invention the management unit is operative to configure any of the controllers to which the non-protocol-compliant device is attached to act as the proxy.

In another aspect of the present invention the proxy is operative to translate a protocol-compliant command into a command for controlling the non-protocol-compliant device, and send the translated command to the non-protocol-compliant device.

In another aspect of the present invention the protocol is the UPnP™ protocol.

In another aspect of the present invention a method is provided for networked device control, the method including deploying a plurality of networked device controllers operative to implement a protocol of automatic device discovery and control, connecting at least one non-protocol-compliant device to any of the controllers and not configured for use with the protocol prior to being connected to the controller, generating any of an interface and a control element associated with any of the devices, establishing a proxy configured for use with the protocol and operative to control the non-protocol-compliant device, and configuring any of the controllers with the interface and control element generated for the device connected to the controller.

In another aspect of the present invention the method further includes configuring any of the controllers to which the non-protocol-compliant device is attached to act as the proxy.

In another aspect of the present invention the generating step includes defining a non-protocol-compliant device type, including a command set, a communication protocol, and an interface, and generating the proxy from the definition.

In another aspect of the present invention the method further includes translating a protocol-compliant command into a command for controlling the non-protocol-compliant device, and sending the translated command to the non-protocol-compliant device.

In another aspect of the present invention a method is provided for networked device control, the method including deploying a plurality of networked device controllers operative to implement a protocol of automatic device discovery and control, connecting at least one protocol-compliant device to any of the controllers and configured for use with the protocol prior to being connected to the controller, connecting at least one non-protocol-compliant device to any of the controllers and not configured for use with the protocol prior to being connected to the controller, generating any of an interface and a control element associated with any of the devices, establishing a proxy configured for use with the protocol and operative to control the non-protocol-compliant device, and configuring any of the controllers with the interface and control element generated for the device connected to the controller.

In another aspect of the present invention the method further includes configuring any of the controllers to which the non-protocol-compliant device is attached to act as the proxy.

In another aspect of the present invention the generating step includes defining a non-protocol-compliant device type, including a command set, a communication protocol, and an interface, and generating the proxy from the definition.

In another aspect of the present invention the method further includes translating a protocol-compliant command into a command for controlling the non-protocol-compliant device, and sending the translated command to the non-protocol-compliant device.

In another aspect of the present invention a method is provided for communicating UPnP™ commands to a non-UPnP™-compliant device, the method including converting a control specification of a non-UPnP™-compliant device into a mapping between at least one non-UPnP™ command and at least one UPnP™ command, creating an instance of a UPnP™ device to receive UPnP™ commands and output a corresponding command to the non-UPnP™-compliant device, looking up a UPnP™ command in the mapping, and sending a corresponding command to the non-UPnP™-compliant device.

In another aspect of the present invention the control specification is that of any of a serial, IR, relay, I/O, or USB device.

In another aspect of the present invention the converting step includes converting into an xml-based format.

In another aspect of the present invention the method further includes receiving a command from the non-UPnP™-compliant device, looking up a UPnP™ command in the mapping corresponding to the received command, and sending the UPnP™ command to a UPnP™ controller.

In another aspect of the present invention the creating step includes creating the UPnP™ device for a subsystem to which multiple sub-appliances are connected, the UPnP™ device having one UPnP™ service for each sub-appliance type, and each of the UPnP™ services having separate references for each of the sub-appliances.

In another aspect of the present invention the method further includes translating a UPnP™ command into a command, sending the command to the subsystem together with an identifier of any of the subappliances to which the command is directed.

In another aspect of the present invention the method further includes automatically assigning an interface element with any of the commands, and upon the interface element being activated, performing the lookup and sending steps with respect to the command associated with the interface element.

It is appreciated throughout the specification and claims that references to UPnP™ may refer to the UPnP™ protocol or any other protocol that provides for discovering, communicating with, and controlling devices and appliances within a computer network environment.

It is appreciated throughout the specification and claims that references to “devices” and “appliances” without further qualification are interchangeable and refer to electrical devices, whereas references to “UPnP™ devices” refer to a UPnP™ protocol term.

### BRIEF DESCRIPTION OF THE DRAWINGS

The present invention will be understood and appreciated more fully from the following detailed description, taken in conjunction with the drawings in which:

FIG. 1A is a simplified conceptual illustration of a networked device control architecture, constructed and operative in accordance with a preferred embodiment of the present invention;

FIG. 1B, which is a simplified conceptual illustration of various functional aspects of the networked device control architecture of FIG. 1A, constructed and operative in accordance with a preferred embodiment of the present invention;

FIG. 2A is an exemplary implementation of the architecture of FIG. 1A, constructed and operative in accordance with a preferred embodiment of the present invention;

FIG. 2B is a simplified flowchart illustration of an exemplary method of operation of the system of FIG. 2A, operative in accordance with a preferred embodiment of the present invention;

FIG. 3 is an exemplary implementation of a control box physical interface, constructed and operative in accordance with a preferred embodiment of the present invention;

FIG. 4 is an exemplary implementation of a mini control box physical interface, constructed and operative in accordance with a preferred embodiment of the present invention;

FIG. 5 is an exemplary implementation of a touch controller, constructed and operative in accordance with a preferred embodiment of the present invention;

FIG. 6A is a simplified block diagram of an exemplary implementation of a control box, constructed and operative in accordance with a preferred embodiment of the present invention;

FIG. 6B shows the Ethernet device of FIG. 6A in greater detail;

FIG. 6C shows the serial devices of FIG. 6A in greater detail;

FIG. 6D shows the USB devices of FIG. 6A in greater detail;

FIG. 6E shows the cardbus interface of FIG. 6A in greater detail;

FIG. 6F shows the optional PCI slot of FIG. 6A in greater detail;

FIG. 6G shows the X10 device of FIG. 6A in greater detail;

FIG. 6H shows the dry contacts of FIG. 6A in greater detail;

FIG. 7 is a simplified block diagram of an exemplary implementation of a mini control box, constructed and operative in accordance with a preferred embodiment of the present invention;

FIG. 8 is a simplified block diagram of an exemplary implementation of a touch controller, constructed and operative in accordance with a preferred embodiment of the present invention;

FIG. 9A is a simplified conceptual illustration of an exemplary modular design of software for use with the architecture and systems of the present invention, constructed and operative in accordance with a preferred embodiment of the present invention;

FIG. 9B is a simplified flowchart illustration of an exemplary method for graphical interface screen generation for use with the architecture and systems of the present invention, operative in accordance with a preferred embodiment of the present invention;

FIGS. 9C and 9D show an exemplary project properties dialog for use in configuring the present invention;

FIGS. 9E and 9F show an exemplary project structure dialog for use in configuring the present invention;

FIGS. 9G-9I show an exemplary Add Device wizard for use in configuring the present invention;

FIG. 9J shows an object action dialog for use in configuring the present invention;

FIG. 9K is a template selection dialog for use in configuring the present invention;

FIG. 9L is an object notification dialog for use in configuring the present invention;

FIG. 9M is a task definition dialog for use in configuring the present invention;

FIG. 9N is a conditions management dialog for use in configuring the present invention;

FIGS. 9O and 9P are device condition selection dialogs for use in configuring the present invention;

FIGS. 9Q-9S are device task dialogs for use in configuring the present invention;

FIG. 9T is an automation management dialog for use in configuring the present invention;

FIG. 10 is a simplified control point flow diagram, constructed and operative in accordance with a preferred embodiment of the present invention;

FIGS. 11A and 11B are simplified conceptual diagrams showing dial-up remote access control of the present invention;

FIG. 12 is a simplified flow diagram of a method for communication with a serial device, operative in accordance with a preferred embodiment of the present invention;

FIG. 13 is a simplified flow diagram of a method for communication with a subsystem, operative in accordance with a preferred embodiment of the present invention; and

FIG. 14 is a simplified block diagram of a media server architecture, constructed and operative in accordance with a preferred embodiment of the present invention.

### DETAILED DESCRIPTION OF THE INVENTION

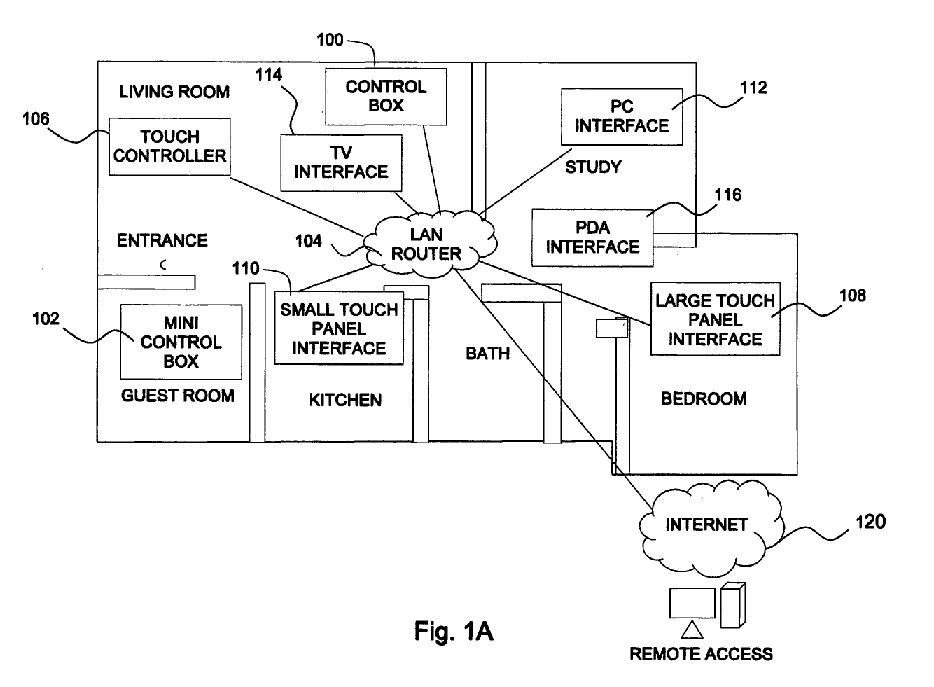

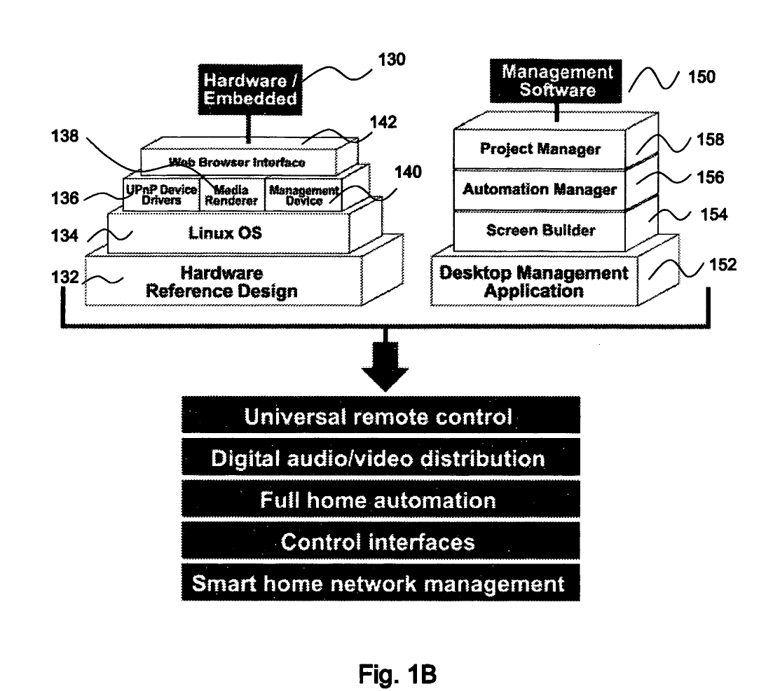

Reference is now made to FIG. 1A, which is a simplified conceptual illustration of a networked device control architecture, constructed and operative in accordance with a preferred embodiment of the present invention. In FIG. 1A, one or more networked device controllers, such as a control box 100 and a mini control box 102, communicate with each other via a network, such as a local area network (LAN) 104 which may be a Wi-Fi network, with one or more controllers, such as a touch controller 106, and with one or more interfaces, such as a large touch panel interface 108, a small touch panel interface 110, a PC interface 112, a TV interface 114, and a PDA interface 116. Communication with any of the control boxes, controllers, and interfaces is provided via one or more remote access terminals 118, such as a personal computer, which may be connected to LAN 104 via a network 120, such as the Internet. The architecture of FIG. 1A provides access to and control of a) audio and video content streaming, such as between PCs, televisions, stereos, cable boxes, and other media points, b) computing devices, c) network-based resources, such as those accessible via the Internet, and d) electronic devices, such as appliances, lighting, and thermostats, using standardized network communications protocols, such as Universal Plug and Play (UPnP™), in a networking environment.

UPnP™ or similar protocols such as Rendezvous™ are preferably used to provide interoperability between electronic devices, including home appliances, and computing devices in a network environment. There are five basic steps involved in UPnP™ Networking: addressing, discovery, description, control and eventing. These steps allow a device to dynamically connect to a local IP-based network, advertise its functionality or be discovered by other elements (i.e., control points) on the network. After a control point has become aware of a device's capabilities and obtained the relevant access permission, it may control the device by sending an action request to the device, which may respond with an appropriate event message containing the names of one or more state variables and the current value of those variables. Implementation and other aspects of the architecture of FIG. 1A are described in greater detail hereinbelow with reference to FIGS. 1B-8.

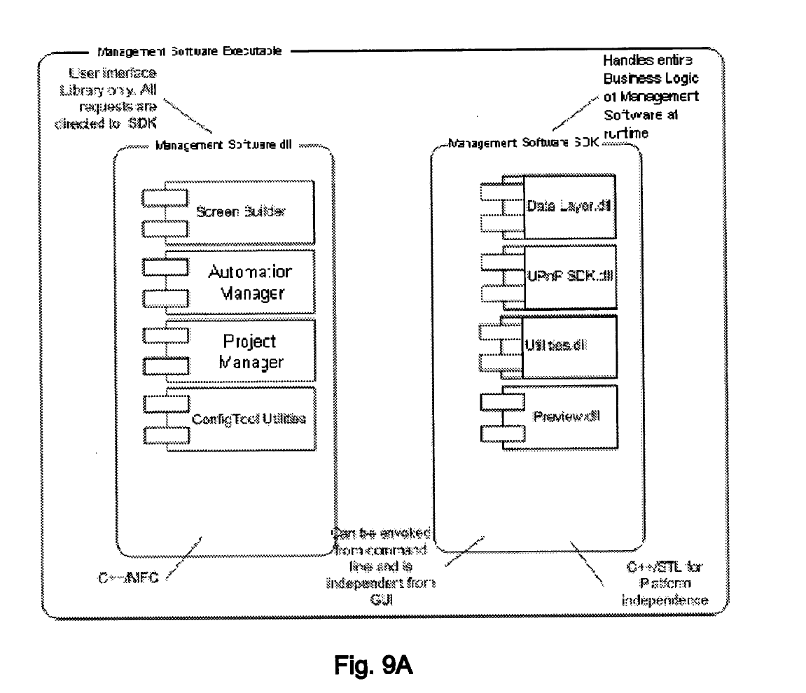

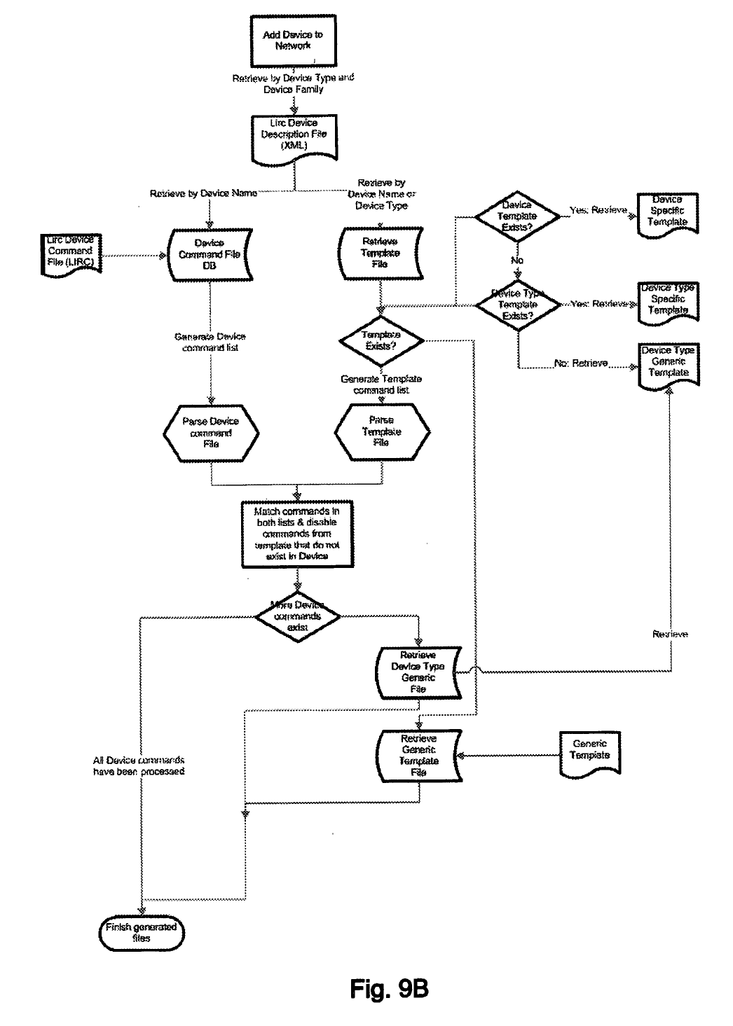

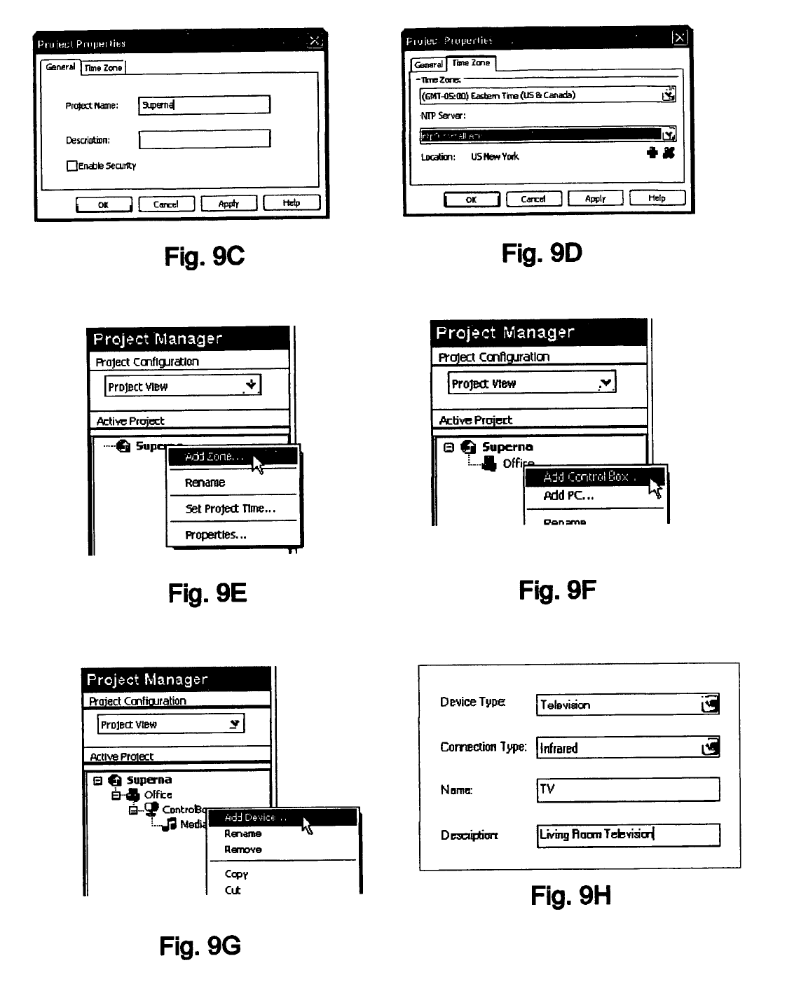

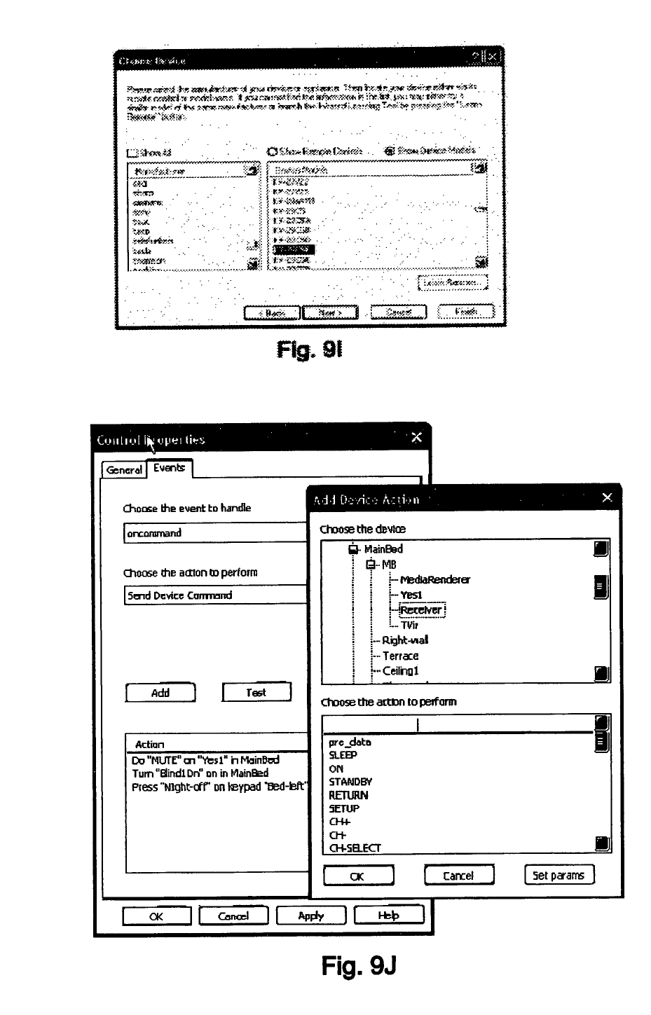

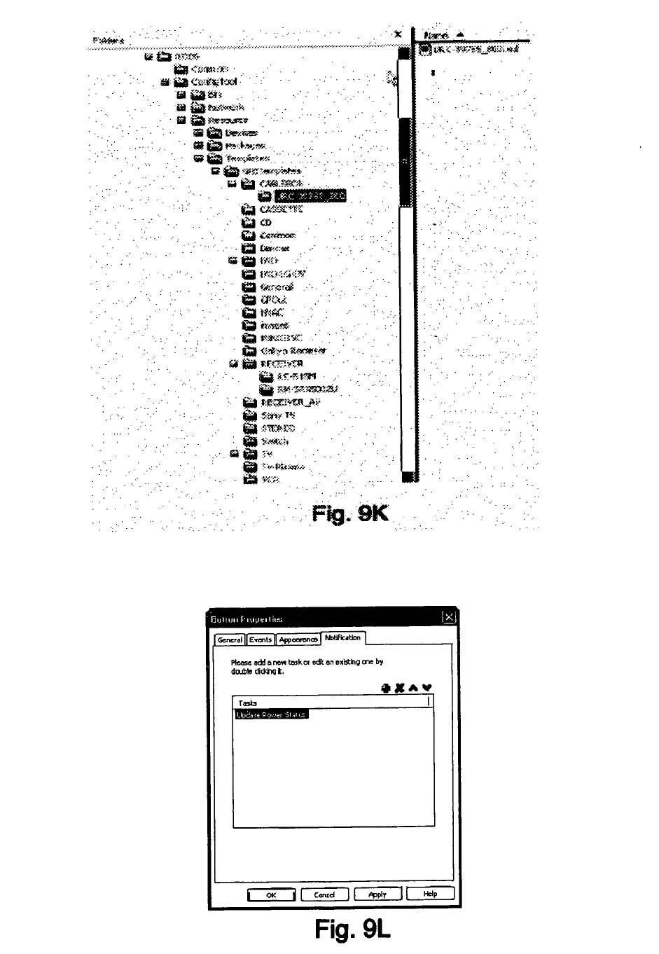

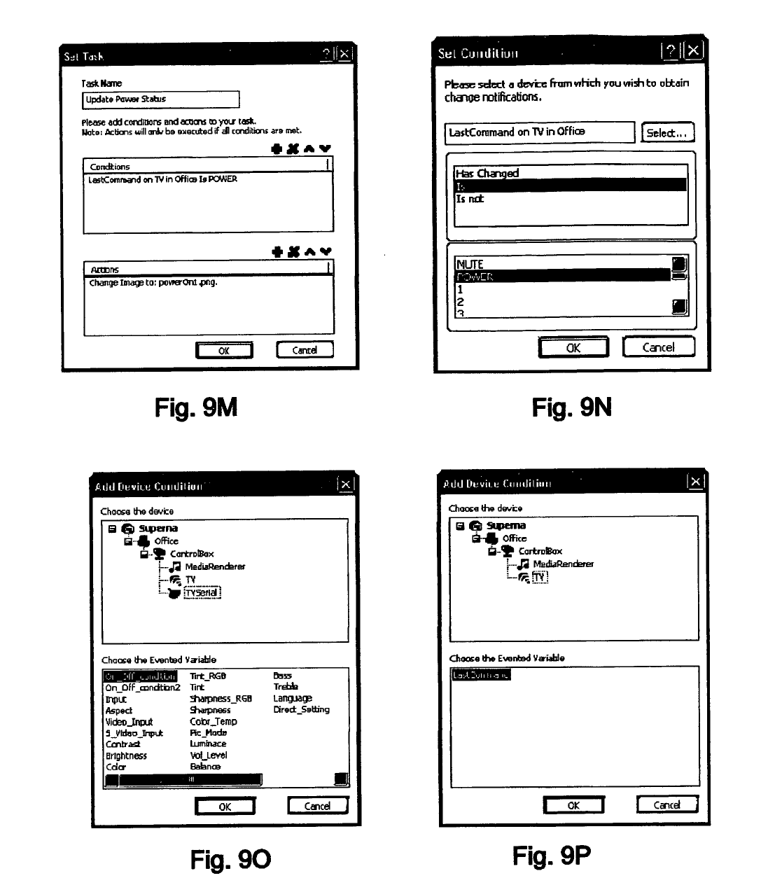

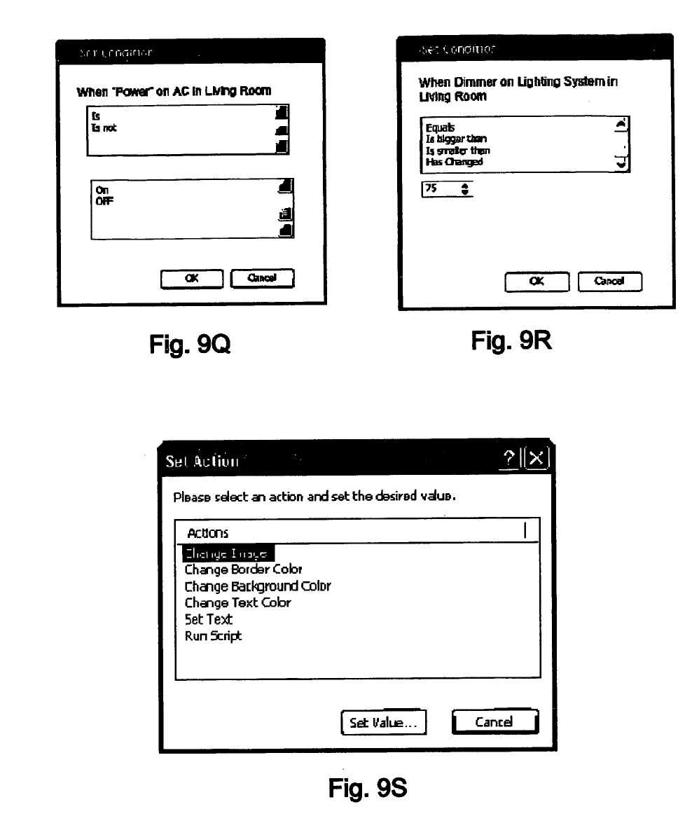

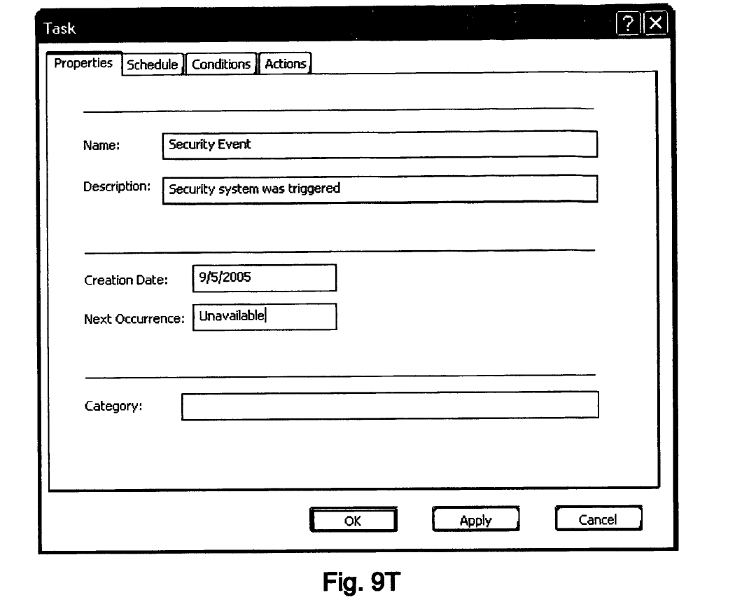

A system based on the architecture of FIG. 1A may be installed in various environments, such as in a home environment, and controlled with management software, such as that which is described in greater detail hereinbelow with reference to FIGS. 9A-14. Such software may be used to provide project configuration and management and personalized interface creation. System interfaces may be displayed via any device with browser capabilities, including PCs, TV screens, PDAs, touch panels and mobile/cellular telephones.

Reference is now made to FIG. 1B, which is a simplified conceptual illustration of various functional aspects of the networked device control architecture of FIG. 1A, constructed and operative in accordance with a preferred embodiment of the present invention. FIG. 1B depicts the architecture of FIG. 1A in terms of its hardware elements, generally designated 130, and its management software, generally designated 150. Hardware elements 130 preferably include a hardware reference design 132 including embedded systems controlled by a operating system 134, such as Linux, which in turn control UPnP™ device drivers 136, and a media renderer 138. Hardware elements 130 are preferably accessed via an interface 142, such as a web browser via a management device component 140. Management software 150 preferably includes a desktop management application 152 including a control screen builder 154, an automation manager 156, such as may be adapted for home automation, and a project manager module 158. When taken together, hardware elements 130 and management software 150 preferably provide universal remote control capabilities, digital audio/video distribution, environment automation, such as of the home environment, project configuration and maintenance, and configuration wizards, as will be described in greater detail hereinbelow.

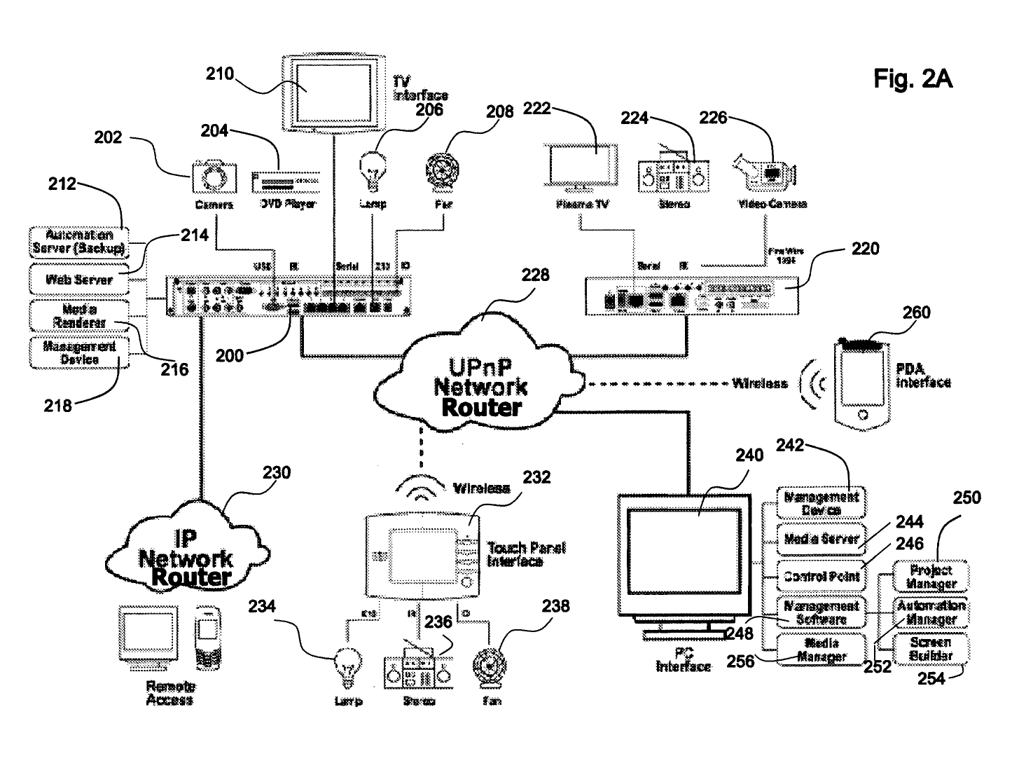

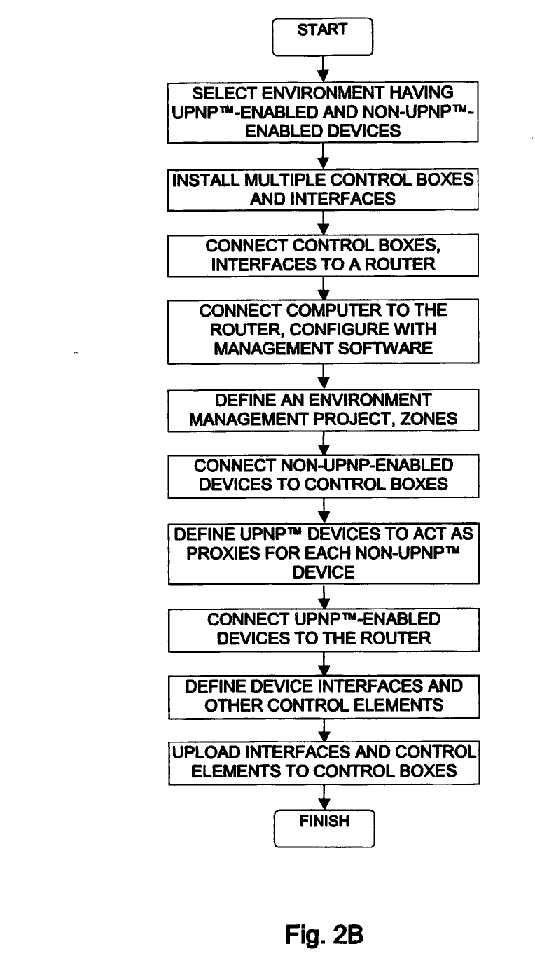

Reference is now made to FIG. 2A, which is an exemplary implementation of the architecture of FIG. 1A, constructed and operative in accordance with a preferred embodiment of the present invention. In FIG. 2A a control box 200 is shown connected to a camera 202, such as via a USB connection, a DVD player 204, such as via an infrared (IR) connection, a lamp 206, such as via an X10 connection, and a fan 208, such as via an electrical switch. Control box 200 is also shown connected to a television 210, such as via a serial connection. Control box 200 may be configured with on-board hardware and software capabilities providing an automation server 212, which may serve as a primary or backup automation server, a web server 214, a media renderer 216, and a management device 218, any of which may be accessed via an interface provided on television 210. A mini control box 220 is also shown connected to a plasma television 222 (via serial), a stereo 224 (via IR), and a video camera 226 (via Firewire 1394a). Both control box 200 and mini control box 220 are shown connected to a UPnP™ network 228, while control box 200 is also shown connected to an IP network 230, such as the Internet, through which remote access to control box 200, and, by extension, to the entire system of FIG. 2A, may be provided. A touch panel interface 232 is shown connected to a lamp 234 (via X10), a stereo 236 (via IR), and a fan 238 (via an electrical switch), and is in wireless communication with network 228. A PC interface 240 is also shown in communication with network 228, and is shown configured with a management device 242, a media server 244, a control point 246, and management software 248. Management software 248 preferably includes a project manager 250, an automation manager 252, and a screen builder 254. A PDA interface 260 is also shown in wireless communication with network 228.

Management devices 218 and 242 may be implemented as UPnP™ devices for the device controllers (i.e., control box, pc). Its main purpose is to function as the gateway to the device controller, providing information services about the device controller capabilities (e.g., number of ports, available disk space, etc.) and providing management capabilities (e.g., uploading configuration files, interface screens, etc.) Additionally, the management devices may incorporate utility services, providing access to the specific device controller's hardware and software environment (e.g., adjust brightness on touch panel, switch alpha-blending on control box, etc.)

In the example shown, control boxes 200 and 220 provide physical connections to home appliances and host software which manage the use of the appliances. Control boxes 200 and 220 have physical interfaces to various types of connectors found in target devices, an function as a bridge between a UPnP™ compliant network and non-UPnP™ compliant, legacy systems and appliances. Control boxes 200 and 220 may be implemented using the following commercially-available hardware components:
Hitachi SH4—a CPU optimized for integration into small-sized processing devices. Main attributes include high MTBF (mean time between failures), low power consumption, and significantly lower price than the equivalent Intel X86;
Sigma Designs 8621L—a companion chip that supports the main processor, providing additional support for superior audio and video performance;
Nand Flash 64 mb Memory (on board)—Expansion can be realized via a Flash MMC slot and may accommodate commercially-available MMC card sizes.

Control boxes 200 and 220 may include any of the following connectors:
802.11a/b/g upgradeable Wi-Fi components;
High Speed USB 2.0 ports;
FireWire 1394a interface, including power management support;
Fast Ethernet (100 Mbps);
Serial interfaces RS232/422/485;
X10 Interface;
IR Interfaces—transmitters and receivers;
General purpose I/O.

Reference is now made to FIG. 2B, which is a simplified flowchart illustration of an exemplary method of operation of the system of FIG. 2A, operative in accordance with a preferred embodiment of the present invention. In the method of FIG. 2B, an environment, such as a home environment, includes UPnP™-enabled and non-UPnP™-enabled devices and appliances, and is configured by installing multiple control boxes and interfaces (e.g., touch panels) and connecting them to a router, either via a wired connection or wirelessly, such as where the router servers as a wireless access point. A computer, such as a desktop-based personal computer, is also connected to the router and is configured with management software described in greater detail hereinbelow. The management software is then used to define an environment management project, where the environment is divided into one or more zones, where each control box is assigned to zone, although a zone may have more than one control box. Non-UPnP-enabled appliances may then be connected to the various control boxes. The management software is then used to define a UPnP™ device to act as a proxy for each non-UPnP™ appliance connected to a control box. UPnP™-enabled devices may also be connected to the router, such as via wireless access. Interfaces and other control elements, such as commands, are then defined for controlling each attached device, either automatically, where the management software automatically generates interface screens and other control elements from predefined templates and device definitions (e.g., lirc infrared format), or as otherwise may be defined and provided by the user. The device interfaces and other control elements are then uploaded to the control boxes to which the devices are connected.

It will be appreciated that the steps of the method of FIG. 2B may be carried out in a different order than shown, such as where the various devices are connected to control boxes only after the project, zones, interfaces, and control element are defined. It will further be appreciated that references to “control box” herein may apply to control boxes and anything that includes any function subset of a control box, such as a mini control box, a touch controller, or another computing device configured to act as a control box, such as where a PC acts as a control box for a connected serial appliance.

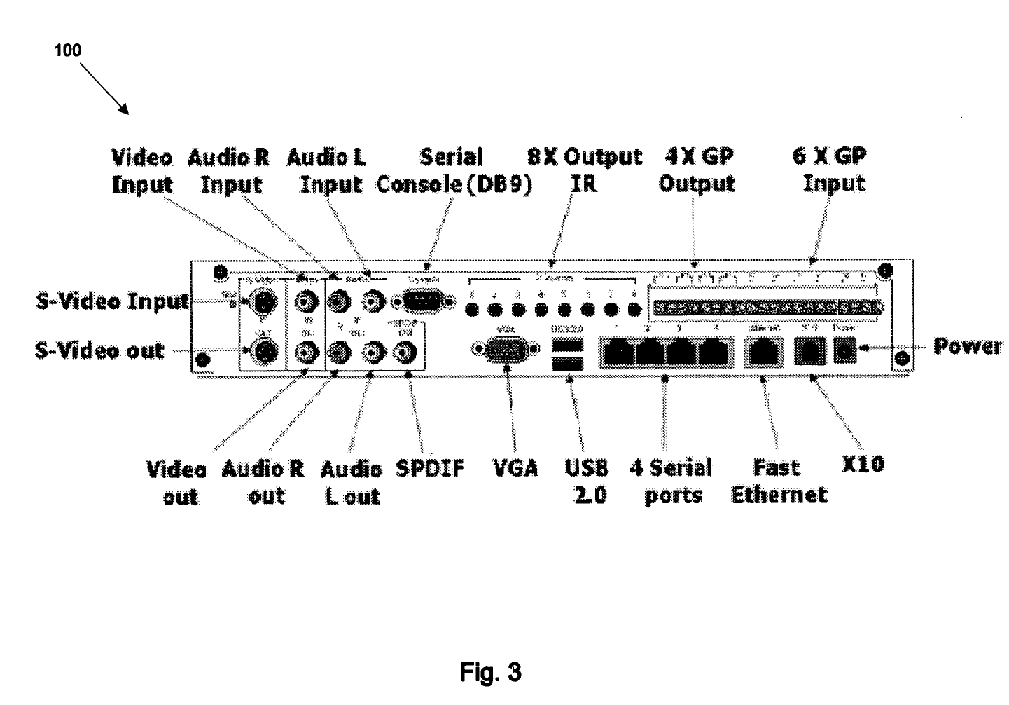

Reference is now made to FIG. 3, which is an exemplary implementation of a control box physical interface, constructed and operative in accordance with a preferred embodiment of the present invention. In FIG. 3 a control box physical interface 300 is shown having multiple connectors and interfaces, including Ethernet, Wi-Fi, IR, Serial, I/O, USB, audio, Video and PCI interfaces, for connecting to various electrical devices, such as including home appliances. These physically connected devices can be operated and controlled from different control points within the home network environment, such as via PCs, LCD touch panels, PDAs, or remote control devices, as well as remote control points, such as mobile phones, remote PCs, and landline-based phones The control box receives the commands from control points over the home network, translates them into commands that the target device understands or actions that can otherwise be implemented upon the target device, and redirects the command to the target device or performs the action upon the target device.

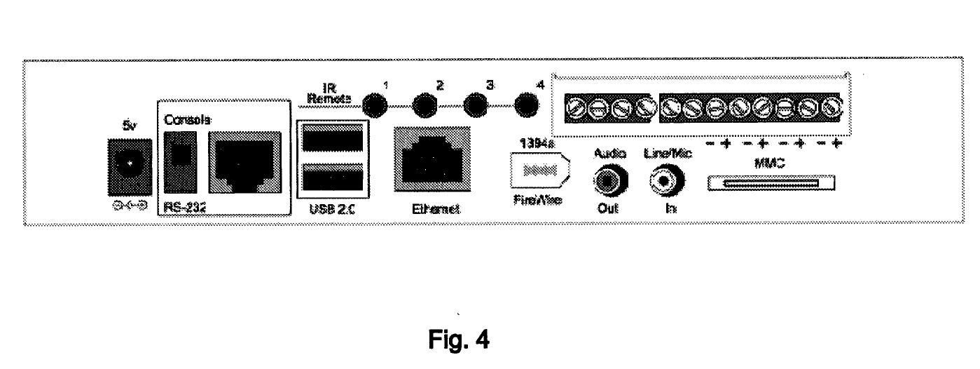

Reference is now made to FIG. 4, which is an exemplary implementation of a mini control box physical interface, constructed and operative in accordance with a preferred embodiment of the present invention. In FIG. 4 a mini control box physical interface 400 is shown having multiple connectors and interfaces, typically having fewer connectors than the control box of FIG. 3.

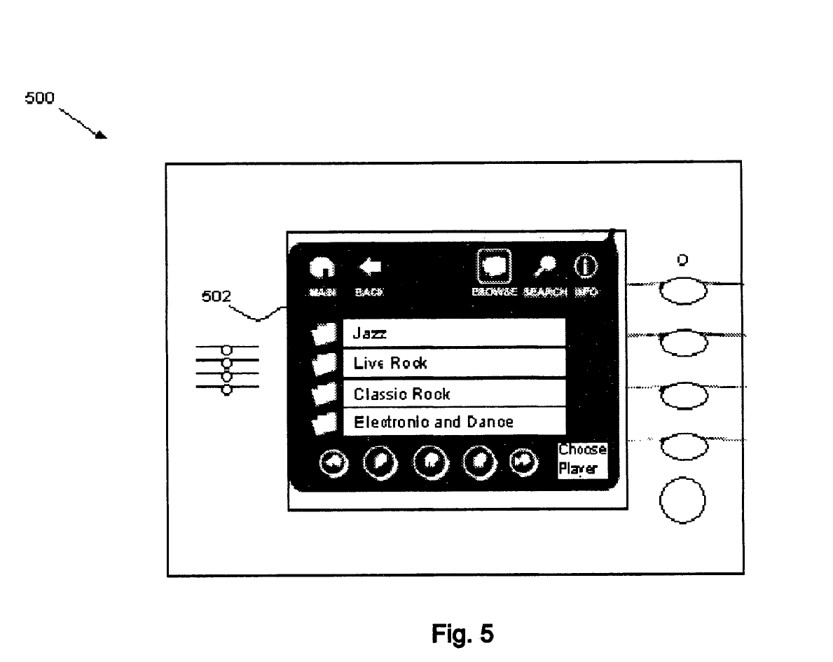

Reference is now made to FIG. 5, which is an exemplary implementation of a touch controller, constructed and operative in accordance with a preferred embodiment of the present invention. In FIG. 5 a touch controller 500 is shown having a touch screen interface 502, which may be an LCD touch panel. Controller 500 typically may have the same internal hardware as that of the mini control box, including the physical connectors for connecting to external devices. Controller 500 preferably contains an integrated power supply within the chassis of the touch controller and is preferably wall-mountable.

Referring now to FIGS. 2-5, the present invention provides a distributed processing architecture, where each control box is responsible for the processing of control and automation tasks related to the devices connected to it. This approach allows for additional control boxes to be added to an existing system without overloading the entire system.

Each control box is preferably controlled by a control operating system (Control OS), being cross-platform, portable system software that, analogous to an operating system, acts as a broker between the hardware and the software applications and services. The Control OS preferably includes the following features:
New device discovery and attachment, including the distribution of new configuration and user interface data to the entire project;
Cross-platform user interface generator;
Standard UPnP™ media server and media renderer for Microsoft Windows™ and Linux operating systems, allowing distribution of digital content to audio/video devices;
UPnP™ control point, including a small portable stack for Linux operating systems;
UPnP™ device templates including support for serial RS232/422/485, USB, and IR.

Referring again to FIG. 2A, management software 248 may be implemented as a Microsoft Windows™-based software application, which facilitates the creation, maintenance and management of device control interfaces and profiles. Management software 248 preferably provides the following:
Definition and installation of a networked device control project, such as in an automated home environment, that allows users to configure the project according to their specific Non-UPnP™ appliances and subsystems as well as UPnP™ appliances;
Interface screen generation—Every device participating in the project needs to be controllable. The screen generator allows users to create the control interface which appears on control points throughout the house, in a way that fits the size, resolution and other attributes of each control point;
Live software updates, online support and troubleshooting.

Media server 244 is preferably implemented as a UPnP™ device that provides audio/video content (i.e., media) to other UPnP™ devices on the network. It is based on the UPnP™ AV Architecture Framework and exposes its content via the Content Directory service. As such, the media server 244 can preferably handle any specific type of media, data format, and transfer protocol, and expose a wide-variety of content such as MPEG-1, -2 and -4 video, CD audio, MP3 and/or WMA audio, JPEG images, and other media to the network in a uniform and consistent manner.

Users interact with the system via an interface, such as is provided by TV interface 210, touch panel interface 232, PDA interface 260, an PC interface 240. The user interface allows users to interact with the system, preferably via a web browser which run on control boxes 200 and 220 and/or on the interface devices themselves. The interface resources may be stored on any of the hardware elements and are served by web server 214.

Automation manager 252 creates and manages scheduled automation project tasks. Automation server 212 may be hosted by a control box, connected PC, or touch panel, and may be implemented as a service/daemon. Scheduled automation tasks may include commands, such as Microsoft Windows™ commands, scripts, UPnP™ commands, as well as other tasks. A scheduled task may also be associated with a date/time event.

Automation manager 252 is a visual tool designed to create and manage all aspects of the automation project. Automation manager 252 is fully integrated with management software 248 and preferably functions as the main automation management interface. Alternatively, a limited automation manager may be provided via the user interfaces (i.e., TV, touch panel, PDA, etc.).

UPnP™ network 228 typically includes one or more UPnP™ devices, being a container of services and nested devices. For example, a VCR device may include a tape transport service, a tuner service, and a clock service. A TV/VCR combo device would include not just services, but nested devices as well. Different categories of UPnP™ devices may be associated with different sets of services and embedded devices. For example, services within a VCR will be different than those within a printer. The set of services that a particular device type may provide is typically captured in an XML-based device description document that the device UPnP™ hosts. In addition to the set of services, the device description also lists properties associated with the device, such as the device name and associated icons.

Being the smallest unit of control in a UPnP™ network, a service exposes actions and models its state with state variables. For example, a clock service may be modeled as having a state variable, current_time, which defines the state of the clock, and two actions, set_time and get_time, through which the service may be controlled. Similarly to the device description, this information is typically part of an XML-based service description. A pointer to these service descriptions, such as a URL, is contained within the device description document.

A service in a UPnP™ device is typically associated with a state table, a control server and an event server. The state table models the state of the service through state variables and updates them when the state changes. The control server receives action requests, such as set_time, executes them, updates the state table, and returns responses. The event server publishes events to interested subscribers anytime the state of the service changes. For example, a fire alarm service may send an event to interested subscribers when its state changes to “ringing.”

A control point in a UPnP™ network, such as control point 246, is a controller capable of discovering and controlling other devices. After discovery, a control point may:
retrieve the device description and get a list of associated services;
retrieve service descriptions for each service;
invoke actions to control the service;
subscribe to the service's event source. Anytime the state of the service changes, the event server may send an event to the control point.

Exemplary implementations of elements of the present invention are now described. While specific hardware components may be referred to by manufacturer and model, such references are provided for illustration purposes only, and it will be appreciated that the present invention is not limited to the specific hardware components mentioned.

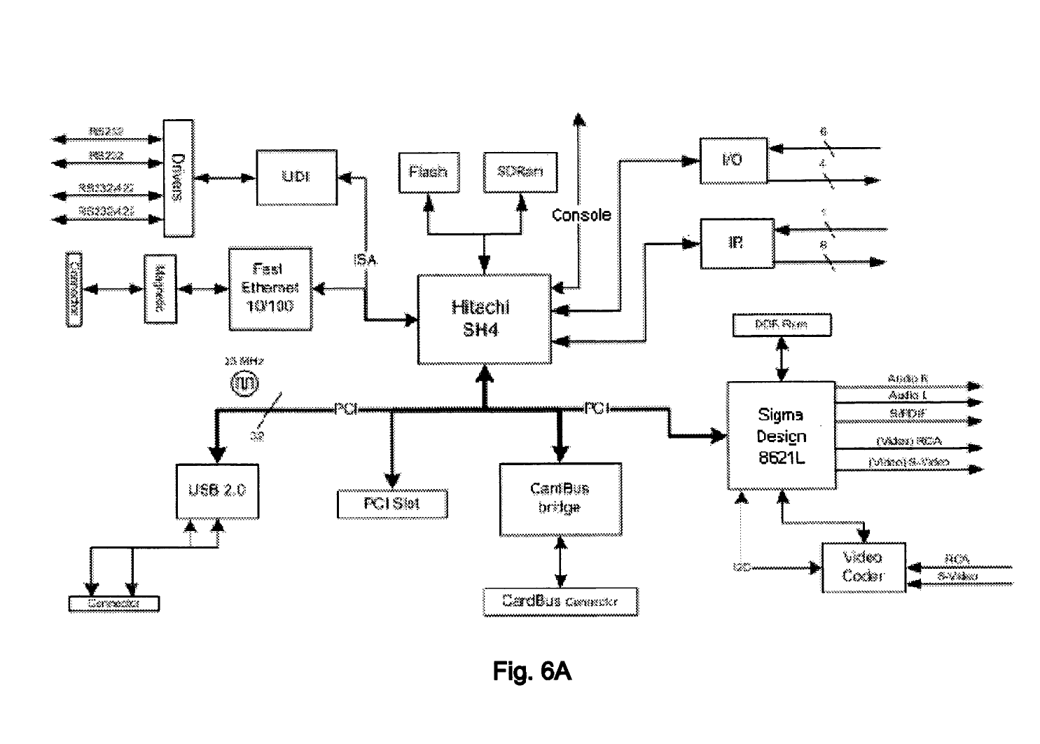

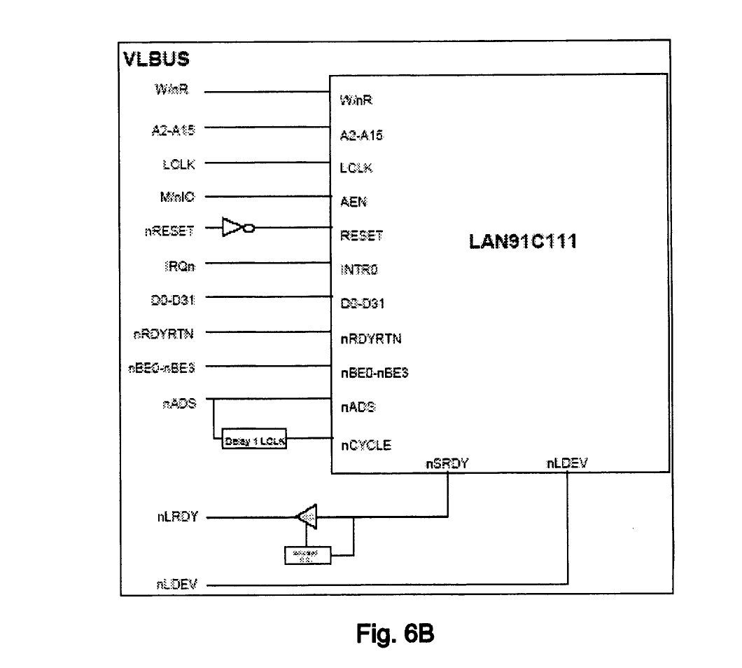

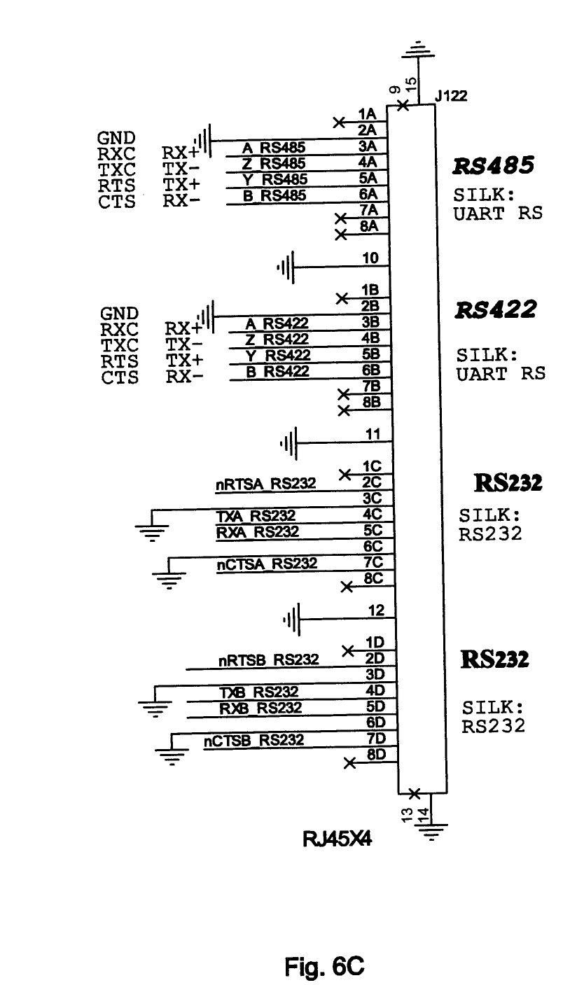

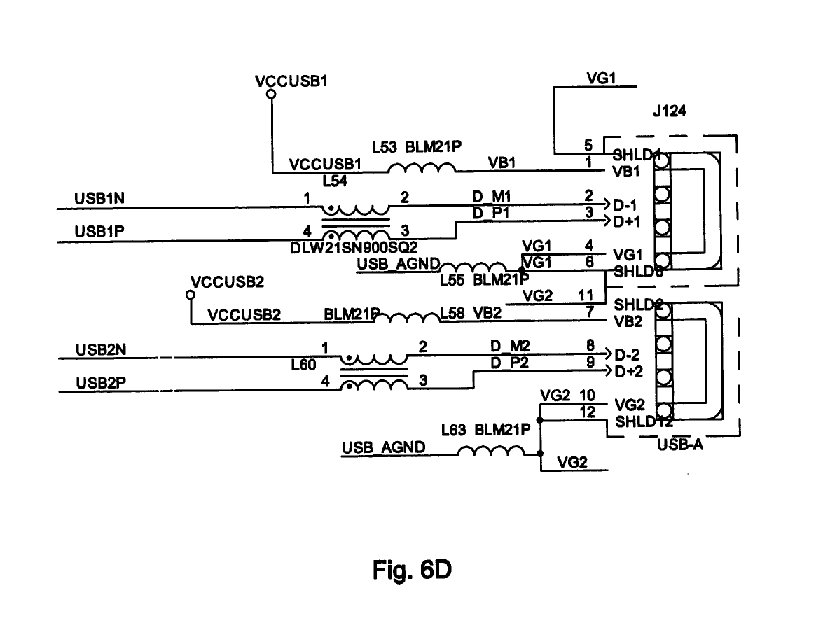

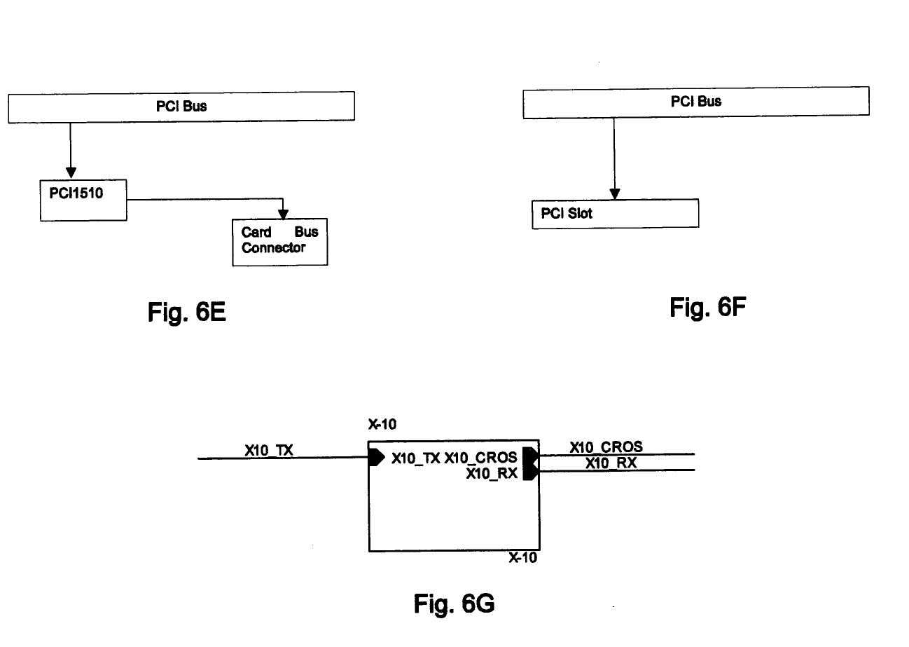

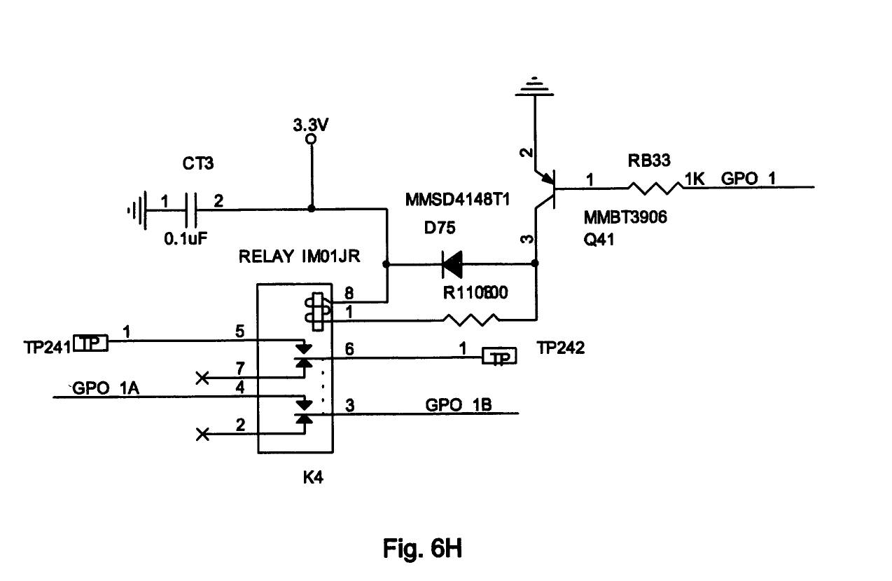

Reference is now made to FIG. 6A, which is a simplified block diagram of an exemplary implementation of a control box, constructed and operative in accordance with a preferred embodiment of the present invention. In FIG. 6A a CPU is shown, such as an Hitachi SH4 SH7751R processor having a 330 Mhz core clock with 590 MIPS capability. A main peripheral bus is shown, which may be is a standard 33 bit, 33 MHz PCI that is preferably capable of supporting at least four devices with no bridge. The control box preferably supports at least one standard PCI board that can be added to the control box via a standard PCI slot. An audio and video possessor is also shown, such as a Sigma Designs model 8621L, with MPEG-1/2/4 capabilities. The implementation of FIG. 6A typically includes the following features:
Card Bus support enabling 802.11b/a/g standards;
S-Video and composite input and output for the video;
RCA Left/Right and SPDIF for the audio;
Fast Ethernet 802.3 (10/100 Mbps) and 802.11a/b/g;
Two USB 2.0 connectors;
One IR receiver and eight IR transmitters;
Six optional inputs from external devices and four dry contact relay connections;
Four connectors for RS-232, RS-422 and RS-485 serial protocol support.

Reference is now made to FIGS. 6B-6H, which describe elements of FIG. 6A in greater detail.

In FIG. 6B the Ethernet device of FIG. 6A is shown in greater detail, which may be a LAN91C111, commercially-available from Davicom Semiconductor Inc., is shown connected to the ISA Bus, preferably in synchronous mode provided by the CPU. The Ethernet interface preferably operates at a working speed of 10/100 MBPS and complies with the 802.3 standard. The Ethernet device provides an interrupt signal, which is shared with the USB device.

The control box of FIG. 6A preferably provides multiple serial interfaces, such as five serial interfaces as shown in FIG. 6C supporting one RS-232 Console, two RS-232 ports, one RS-232/RS-422 port, and one RS-232/485 ports, all of which are preferably generated by a single device. This device functions as a bridge between the serial protocol and the local bus, which may be an SH-4 ISA local bus. The device provides a MAC address and additional PHY for each serial connection in order to generate the physical signaling level.

An RS-232 Console driver is preferably provided to provide recognition indications and interrupts are supported by the interface.

The RS-232 port is preferably supported by the serial port driver and provides standard data transfer rates. There are two RS232 serial ports that are fully compatible with the RS232 protocol.

The RS-485 port is preferably supported by the serial port driver and is fully compatible with the RS485 protocol. Its functionality as RS-232 can be set at boot time.

The RS422 port is preferably supported by the serial port driver and is fully compatible with the RS422 protocol. Its functionality as RS-232 can be set at boot time.

The operating system preferably interfaces with the device via the ISA bus. The generated interrupt signal may be shared by all serial ports and preferably causes a voltage transition from low to high which pulls down the INT_UART signal generating the interrupt. The UART interrupt may be shared with the PCI slot interrupt and the operating system determines which device generated the interrupt. The operating system may access the entire device internal register.

There are preferably four additional controlling signals, nCSA-nCSD, where each signal acts as the chip select for the serial interfaces. The operating system preferably generates the CS signal and a Reset signal for the serial interface device.

Additionally, two selectors generated from GPIO are the serial PHY selector that set the two line standard RS-232/RS422 and RS-232/RS-485. The settings are preferably determined via software.

The circuit attached to the physical serial connector is one of the PHY's with the selection line. A TL16C554A, commercially-available from Texas Instruments Inc. may be connected from top to bottom as shown in FIG. 6A as follows:
RS-232/RS-285
RS-232/RS-244
RS-232
RS-232
   The console is connected to the SH-4 UART port as shown in FIG. 6A.

The USB device of the control box of FIG. 6A may be implemented as shown in FIG. 6D, connected to the PCI Bus and providing four master ports capable of providing USB 2.0 connectivity. The USB device may be a VT6202/VT6212, commercially-available from VIA Technologies, Inc. Each of the USB ports may generate an interrupt. The USB controller preferably includes a power monitoring device that monitors the voltage and current provided to the connector and disconnects the power in case of over current. A USB driver is also provided that preferably supports USB 1.1 and USB 2.0 with speeds of up to 480 Mbit/sec.

The cardbus interface of the control box of FIG. 6A may be implemented as shown in FIG. 6E, such as a TI PCI1510, commercially-available from Texas Instruments, Inc., supporting a 32 bit, 33 MHz single slot cardbus dedicated to the Wi-Fi interface supporting 802.11a/b/g. Preferably, any third-party Wi-Fi card may be inserted into the slot. The support card bus (32 bit) and PC card (16 bit) preferably support hot swapping and are fully compatible with the PC Card and Card Bus specifications.

An optional PCI slot may be provided with the control box of FIG. 6A and may be implemented as shown in FIG. 6F, supporting one 32 bit, 33 MHz single slot Standard PCI board. Any third-party card can be inserted into the slot. The standard PCI slot is preferably provided, connected to the first interrupt, and shared with the serial controller.

An X10 device may be provided with the control box of FIG. 6A and may be implemented as shown in FIG. 6G. The X10 hardware preferably supports the X10 PHY where three signals control the X10 protocol. The interrupt generated by the X10 device is preferably shared. The X10 device driver is preferably compatible with the X10 protocol.

The control box of FIG. 6A preferably includes one or more input signal indicators that are connected to a input voltage comparator that provides the threshold point and the transaction to TTL logic levels. Dry contacts are preferably provided and are controlled by GPIO, such as the four dry contacts shown by way of example in FIG. 6H. A driver is provided that enables recognition and reads each input status. It controls the relays by writing and reading from a dedicated register.

The control box of FIG. 6A preferably includes an IR receiving device connected either to the SH-4 data bus (D0) or to the interrupt-enabled pin. A driver is provided that supports the IR receiver, and the operating system samples the IR receiver either by polling or by interrupt. The operating system, which preferably incorporates an open source device driver handling the IR communication, such as LIRC, preferably allows reading from this port.

The control box of FIG. 6A preferably supports multiple Tx IR transmitters, where each has an associated driver that is able to control one device. The signaling is derived from GPIO. Typically, only one IR device will be active at any given time. The driver provides access for each IR driver. The software is preferably bundled with the LIRC kernel space driver and provides TX access through the /dev/lirc device.

The control box of FIG. 6A preferably employs an audio/video processing chip, such as a Sigma Designs EM8621L single-chip audio/video decoder for MPEG-1, MPEG-2 MP@HL, and MPEG-4 Advanced Simple Profile Level 5 (without Global Motion Compensation) formats. The EM8621L is designed specifically for applications in advanced set-top appliances including optimization features for tightly embedded applications such as TV/PDP integration, A/V streaming, progressive DVD playback, Video-on-Demand (VOD), Personal Video Recording (PVR) and Picture-in-Picture (PIP). The EM8621L derives from a common architecture, and shares a common set of core features related to video and audio decoding, stream processing, video processing and display, and memory and I/O support. In addition, the devices support numerous popular media formats including DVD-Video, Superbit DVD, DVD Audio, SVCD, VCD1.x, VCD2.0, CD/CD-R/CD-RW (audio, JPEG, MP3 and MPEG-4 AVI files). The devices also support ISMA MPEG-4 streaming format and MPEG-4 over MPEG-2 transport streaming.

The EM8621L can decode multiple simultaneous MPEG programs, based on source format and resolution, including:
SD (720×576 p or less): Two MPEG-4 programs
SD (720×576 p or less): Three MPEG-2 programs

When decoding multiple MPEG programs, each program may be treated differently. One may be played normally, a second program might be used for picture-in-picture and a third program might be output to a second TV or VCR.

The EM8621L hardware and accompanying software support many popular MPEG-based video and audio media formats. The device supports DVD-Video, Superbit DVD, VCD 1.x and 2.0, SVCD, DVD-Audio, CD/CD-R/CD-RW (audio, JPEG, MP3 and MPEG-4 AVI files). The EM8606L includes hardware CSS decryption and supports DVD-Video CSS procedural specifications. It also fully supports DVD-Video control features such as 16:9 and 4:3 aspect ratios, letterboxing, pan and scan, multiple angles, 3:2 pulldown, up to 8 language sound tracks, and 32 subtitle settings.

The EM8621L includes a DSP-based audio decoder. The decoder can support the following audio formats:
DVD-Audio with Meridian Lossless Packing (MLP) option
Dolby Digital 5.1 (Group A)
MPEG-1 Layers 1 and 2
MPEG-1 Layer III (MP3)
MPEG-4 AAC (Low Complexity, 5.1 channels)
Windows Media Audio
16-bit Linear PCM

Audio services required for digital TV applications are also supported. The audio decoder uses three I2S digital audio output interfaces for 5.1 channel support, and a S/PDIF serial output.

The EM8621L device is connected to the PCI Bus as the fourth device and all communication is done thru this channel. An additional device for the video input signal interfaces the EM8621L via the digital video port and is controlled by I2C bus provided by the EM8621L processor. The interrupt generated by the EM8621L is shared with the X10 and Input IR.

The driver supports all features provided by the EM8621L processor and provides an X-server on the graphic device via the I2C bus to the video-in device. The driver is written to work with the Sigma Mono Media Player which handles all audio, video, and image media streaming.

The control box of FIG. 6A preferably includes software that supports multiple media formats, including:
DVD-Video, Superbit DVD, DVD-Audio, SVCD (IEC 62107-2000), VCD 1.x and 2.0
DVD-R, DVD-RW, DVD+R, DVD+RW (conditional, no CPRM)
Audio CD, CD-R, CD-RW, Compact Flash
WMA, JPEG, MP3 and MPEG-41 AVI files
Picture CD (JPEG files).

The control box of FIG. 6A preferably includes software that supports multiple audio formats, including:
MP3 and MPEG-4 AVI
DVD-Audio with Meridian Lossless Packing (MLP) option
Dolby Digital 5.1 (Group A)
MPEG-1 Layers 1 and II
MPEG-1 Layer III (MP3)
MPEG-4 AAC (Low Complexity, 5.1 channels)
Windows Media Audio
16-bit Linear PCM

The control box of FIG. 6A preferably includes software that supports multiple video formats, including:
DVD-Video
Superbit DVD
VCD 1.x and 2.0
SVCD
DVD-Audio, CD/CD-R/CD-RW (audio, JPEG, MP3 and MPEG-4 AVI files

The control box of FIG. 6A preferably includes software that supports multiple streaming formats, including:
ISMA (Internet Streaming Media Alliance) MPEG-4
MPEG-2, MPEG-4, MPEG-4 over MPEG-2 Transport
Input data rates (each program)

The control box of FIG. 6A preferably includes software that supports multiple video decoding standards, including:
MPEG-1, MPEG-2, MP@ML
MPEG-4 Advanced Simple Profile Level. Rectangular shape video decoding up to 720×576, support for B Pictures, data partitioning support for error resiliency, up to 4 objects decoded in CIF Resolution.
DVD-Video and Superbit DVD
CSS decryption
16:9 and 4:3 playback, letterbox, 3:2 pull-down
Multiple angles and sub-picture
Error concealment

The control box of FIG. 6A preferably includes software that supports multiple video processing capabilities, including:
Brightness, color, contrast controls for each output port
Hardware cursor (4096 pixels, 4 bits per pixel, up to 255 pixels horizontally and vertically)
2D graphics accelerator (up to 75M samples per second operation for most operations)
Fill: generate a single-color filled rectangle
Blend: alpha blend one rectangular region onto another
Move: move a rectangular region to another location
Replace: modified version of Move
Line and Rectangle: generate a single-color line or rectangle
Raster Ops: standard 256 Boolean operations
32-bit OSD with flicker filtering and scaling
Optional deinterlacing of interlaced sources
Arbitrary scaling of video and OSD up to 1920×1080 pixels
Alpha mixing of video, cursor and OSD

The control box of FIG. 6A preferably includes software that supports multiple image formats, including:
JPEG, PNG, GIF

The control box of FIG. 6A preferably includes software that supports the usage of the Alpha blending feature. The video will be displayed at the S-video Video RCA.

The control box of FIG. 6A preferably includes software that supports decoding two MPEG-2 or MPEG-4 standard-definition programs simultaneously, enabling support for Picture-in-Picture (PIP).

The control box of FIG. 6A preferably includes software that supports on-screen display (OSD) enabling full-screen graphical menus and images to be blended with the video and subpicture. Preferably, 4 palletized color depths are supported: 2 colors (1 bit per pixel), 4 colors (2 bits per pixel), 16 colors (4 bits per pixel) and 256 colors (8 bits per pixel). A 256×32 color look-up table (CLUT) may be used to convert the 1-, 2-, 4- or 8-bit code into a 24-bit YCbCr color with 256 levels of alpha blending. A 16-bit per pixel format is preferably employed to support the following formats: 565 RGB, 1555 ARGB and 4444 ARGB. 24-bit 888 RGB and 32-bit 8888 ARGB formats are also preferably supported.

The EM8621L includes hardware CSS decryption and supports DVD-Video CSS procedural specifications. It also fully supports DVD-Video control features such as 16:9 and 4:3 aspect ratios, up to 8 language sound tracks, 32 subtitle settings, letterboxing, pan and scan, multiple angles and 3:2 pulldown.

The control box of FIG. 6A preferably includes 128 MB of SDRAM@ 100 MHz divided into two banks, where each bank has its own chip select (CS2 and CS3 respectively). Nand flash may also be used as storage, having an AD interface where the Address, Data, and Command info are run over the same pins.

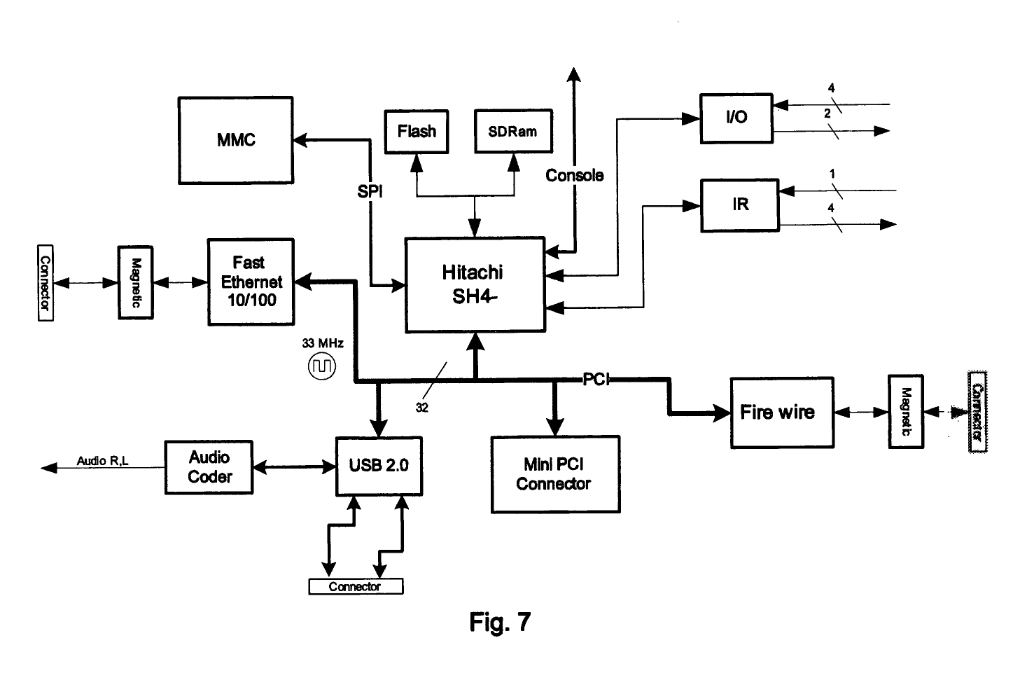

Reference is now made to FIG. 7, which is a simplified block diagram of an exemplary implementation of a mini control box, constructed and operative in accordance with a preferred embodiment of the present invention. The mini control box of FIG. 7 is substantially similar to the control box of FIG. 6A, except as shown and as now described. The mini control box of FIG. 7 preferably includes a CPU core that supports the following memory types:
Boot Flash
SuperAND Flash, 16/32 MB on board
SDRAM 64/128 MB On board.
Expansion Flash MMC type up to 128 MB.

A Fast Ethernet 10/100 Mb is preferably supported with a standard RJ-45 connector type. The transceiver is preferably provided on the internal PCI bus provided by the CPU.

The mini control box is preferably able to interact via wireless LAN (802.11b, 802.11b and 802.11g). The design supports Mini PCI standard in order to support third party W-LAN on Mini PCI. The antenna preferably supports 2.4 G and 5.8 G bands.

The mini control box bus preferably controls standalone applications and allows the connection of expansion devices. The mini control box preferably includes a transceiver on the internal PCI bus provided by the CPU, and drives 15 W of power toward external devices. The connector may be a six wire type needed to supply the power driving the driver for the Firewire itself.

The mini control box preferably supports 4 Tx IR transmitters and each driver is able to control one device. The signaling is derived from the RS-232 DTR signal. Only one IR device may be active at any given time. The connectors are of the microphone type.

The mini control box preferably supports one serial port based on the RS-232 protocol (UART) with an RJ-45 standard connector. The serial port functions as a terminal or user UART interface according to an on-board jumper selection.

Two dry contact relays capable of driving 1 Ampere may be provided.

The mini control box is preferably capable of receiving signaling from external devices with single ended wires. The ground connection is shared for all four inputs.

The mini control box may have a rated voltage of 0-24 VDC, an input impedance of no less then 20 KOhm, and a logic threshold of 1.25V.

The mini control box preferably supports Audio In/Out signaling. In addition to the microphone connector, an optional header may be provided to enable the connection of a board microphone device. The audio/microphone connection may be selective, resulting in the disconnection of the microphone where an external microphone is connected.

The mini control box front panel preferably includes the following items:
Signal IR receiver
IR receive indictor LED
Two color status LED connected to an address mapped to latch or Hitachi GPIO
Power LED.

In addition to the IR receiver, an optional header may be provided to allow the connection of an off-board IR device.

The mini control box back panel preferably includes the following items:
1 Serial connector RJ-45 type according to the standard pin out.
Dual USB Connector Master Type.
One audio out Microphone connector.
One audio in Microphone connector
One Ethernet connector RJ45 type with activity LEDs built in the connector.
One Firewire connector with six pins, four for signaling and two for the power.
Four IR connectors (Microphone connector) for external IR transmitter devices.
Two IO out Relay for the dry contact.

In addition to the microphone connector, an optional header may be provided to enable the connection of a board microphone device. The audio/microphone connection is selective resulting in the disconnection of the microphone in case an external microphone is connected.

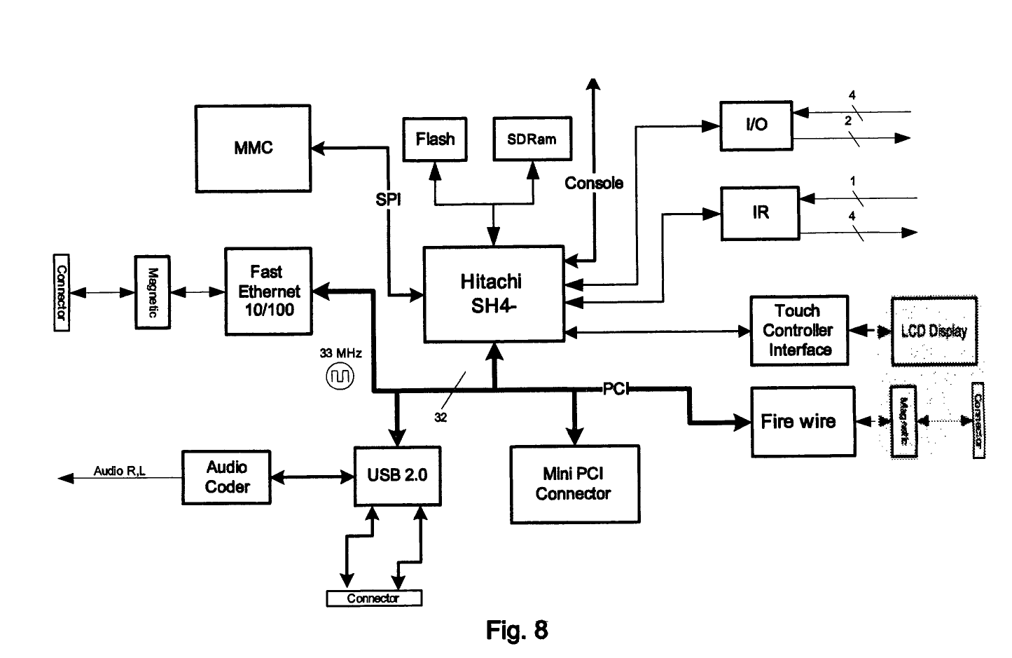

Reference is now made to FIG. 8, which is a simplified block diagram of an exemplary implementation of a touch controller, constructed and operative in accordance with a preferred embodiment of the present invention. The touch controller of FIG. 8 is substantially similar to the mini control box of FIG. 7, except as shown and as now described.

The touch controller includes the general mini control box design, with an additional LCD controller and LCD display. Preferably, the touch controller uses CSTC LCD or Active TFT LCD displays with a resolution of up to 800×600 (SVGA).

The LCD display preferably includes a touch panel cover which is connected to the LCD board. The touch panel controller communicates with the LCD controller device using any suitable means.

The touch controller preferably includes an AC/DC module built into the wall plug chassis enabling it to connect directly to a 85-264V AC power line. The power module is preferably a switching power supply for a standard power line. The output is DC 5V up to 3 A with standard DC plug. Special power wiring is thus not required to power the touch controller, although the power module may be connected to a power source, such as DC 5V. This might be preferable in environments where a 2-wire DC line is already available and/or where a 100-220V AC power line is not available nearby.

Exemplary methods of operation are now described of aspects of the architecture and systems described hereinabove. For illustration purposes only, such methods are described for a home automation project, although it is appreciated that the present invention is equally applicable in other environments as well.

Reference is now made to FIG. 9A, which is a simplified conceptual illustration of an exemplary modular design of software for use with the architecture and systems of the present invention, constructed and operative in accordance with a preferred embodiment of the present invention, and additionally to FIG. 9B, which is a simplified flowchart illustration of an exemplary method for graphical interface screen generation for use with the architecture and systems of the present invention, operative in accordance with a preferred embodiment of the present invention. Elements of FIG. 9A and FIG. 9B that are not self-explanatory are described in greater detail hereinbelow.

Creating an automation project typically involves with taking the basic layout of an environment, mapping the environment into one or more zones, adding control boxes, and attaching devices to the control boxes.

In FIGS. 9C and 9D a project properties dialog is shown as the first step in creating an automation project. Each project can be assigned its specific Time Zone setting, which is preferably stored in a project configuration file. Then, as shown in FIG. 9E, a project structure can be designed by adding one or more zones. This process will create a graphical user interface (GUI) screen which will link to the zone's various devices and control boxes as they are added. A project structure can then be designed by adding one or more control boxes as shown in FIG. 9F by right-clicking on the project explorer area on a zone or from the menu or wizard and selecting “Add ControlBox™”.

One or more devices, such as a non-UPnP™ appliance, can be connected to the project by clicking on the project explorer area on a specific control box or from the menu or wizard and selecting “Add Device”. The term “appliance” is now used to describe any kind of electrical device or appliance. This process will create a GUI which will provide access to the functionality of the added device (e.g. Play a CD). Preferably, every time a device is added to a control box, the zone containing the control box will be automatically regenerated to provide access to the added device.

Selecting the “Add Device” menu item as shown in FIG. 9G will launch the Add Device Wizard. Users may choose the type of devices they want to connect to each control box and operate through the home network, such as is shown in FIG. 9H. The user can connect to elements such as a control box, IR Devices, Serial Devices, X10, Sub System, General Purpose devices or Virtual devices.

Once the type of device is established a database window preferably opens as shown in FIG. 9I containing a list of manufacturers and their models. Each manufacturer has corresponding models. If the device being added is not found in the database the user can enter a new model and specify the device controllers.

After providing all requested data, the wizard will have all the required information. The added device will then appear in the project tree, the proper template files will be located, and the application will retrieve the required device command file and generate the Interface screens.

An “Automatic GUI Generation for Multiple Target Devices” feature is preferably provided to provide a GUI for appliances, which are part of the home automation project as well as project-wide GUI screens that provide access to control boxes and zones throughout the home. The GUI is updated and/or created automatically for each display type available to the home automation project when a zone, control box, or device is added or modified. The user may choose to regenerate any of the existing interfaces as desired to base the interface on a modified template or even a different skin.

The standard display types supported by default are TV, PC, Touch Panel, and PDA, but integration with third-party products such as Windows™ Media Center™ Edition 2005 is supported as well. The system preferably detects any additional target displays as they are added to the system at run-time. The user may add as many additional display devices as needed and have their GUI generated automatically as well. After the various GUIs have been created, the user may choose to modify the visual and functional elements to his/her liking.

At run-time, a user may request to view a specific GUI from a specific display type. The web server receives an “http get” request with a parameter identifying the display type on which the requested file is to be rendered and returns the requested GUI display.

In order for the Automatic GUI process to work properly, the following building blocks are required:
1. Device Command File (e.g., Lirc IR Command file, Serial Command File)
2. Standardized Command names for commonly available device actions (e.g. PLAY, STOP, ENTER, etc).
3. Generic functions embedded and/or merged into the template that execute standardized device commands independent of the device type.
4. GUI generation mechanism that merges a template with a standardized Device Command file to generate a fully functional GUI screen.

The GUI screen preferably provides a simple and consistent layout independent of the GUI object as defined in the template file. The objects on the template (and ultimately the GUI screen) may make use of the intrinsic functionality provided by the GUI objects supported as defined by the UI language used (i.e., XUL & HTML). The user may modify any of the properties and/or events to change the visual appearance and/or functionality in the Editor after automatic GUI generation, respectively. Alternatively, the user may make those changes to the template files before automatic GUI generation.

The following tables list typical object attributes/properties.

Window

| Feature | Attribute | |
|---|---|---|
| Name | Name | Possible Values |
| Skin | Style | Existing Skin as defined in a css file linked |
| | | to the screen |
| Height | Height | Integer values between Min-height and |
| | | max-height |
| Width | Width | Integer values between min-width-maxwidth |
| Left | Left | Integer values between 0 |
| Top | Top | Integer values between 0 |
| ID | Id | Any (required) |
| Description | Tooltiptext | Any (size limitation) |
| Font | Font | Font, size, style (Bold, Italic, Normal) |
| | | underline,color |
| Background | Color | RGB |
| Color | | |
| Background | Image | Any supported file type (e.g. gif, jpg, png) |
| Image | | |

Button

| Feature | Attribute | |
|---|---|---|
| Name | Name | Possible Values |
| Text | Label | Any characters (localization is supported |
| | | by thebrowser) |
| Height | Height | Integer values between Min-height and |
| | | max-height |
| Width | Width | Integer values between min-width-maxwidth |
| Left | Left | Integer values between 0 |
| Top | Top | Integer values between 0 |
| ID | Id | Any (required) |
| Description | Tooltiptext | Any (size limitation) |
| Font | Font | Font, size, style (Bold, Italic, Normal) |
| | | underline,color |
| Background | Color | RGB |
| Color | | |
| Background | Image | Any supported file type (e.g. gif, jpg, png) |
| Image | | |

Frame

| Feature | Attribute | |
|---|---|---|
| Name | Name | Possible Values |
| GUI to | src | This content of the frame is a separate |
| Display | | document. |
| Height | Height | Integer values between Min-height and |
| | | max-height |
| Width | Width | Integer values between min-width-maxwidth |
| Left | Left | Integer values between 0 |
| Top | Top | Integer values between 0 |
| ID | Id | Any (required) |
| Description | Tooltiptext | Any (size limitation) |
| Font | Font | Font, size, style (Bold, Italic, Normal) |
| | | underline,color |
| Background | Color | RGB |
| Color | | |
| Background | Image | Any supported file type (e.g. gif, jpg, png) |
| Image | | |

Label

| Feature | Attribute | |
|---|---|---|
| Name | Name | Possible Values |
| Text | Label | Any characters (Localization is supported |
| | | by thebrowser) |
| Height | Height | Integer values between Min-height and |
| | | max-height |
| Width | Width | Integer values between min-width-maxwidth |
| Left | Left | Integer values between 0 |
| Top | Top | Integer values between 0 |
| ID | Id | Any (required) |
| Description | Tooltiptext | Any (size limitation) |
| Font | Font | Font, size, style (Bold, Italic, Normal) |
| | | underline,color |
| Background | Color | RGB |
| Color | | |
| Background | Image | Any supported file type (e.g. gif, jpg, png) |
| Image | | |

Image

| Feature | Attribute | |
|---|---|---|
| Name | Name | Possible Values |
| Height | Height | Integer values between Min-height and |
| | | max-height |
| Width | Width | Integer values between min-width-maxwidth |
| Left | Left | Integer values between 0 |
| Top | Top | Integer values between 0 |
| ID | Id | Any (required) |
| Description | Tooltiptext | Any (size limitation) |
| Font | Font | Font, size, style (Bold, Italic, Normal) |
| | | underline,color |
| Background | Color | RGB |
| Color | | |
| Background | Image | Any supported file type (e.g. gif, jpg, png) |
| Image | | |

An event generation mechanism is preferably provided which describes the “action” a user wishes to perform when interacting with a GUI (e.g., pressing a button). The template on which the automatic GUI is generated may include actions corresponding to the standard device commands described above, and may invoke additional actions such as executing a script, switching to different screens, or manipulating the visible GUI. For project-wide GUI screens, the template may include links to zones and control boxes. After automatic GUI generation, the user may modify the existing actions assigned to the objects, rearrange the order of the selected actions, or remove an action item. For example, as shown in FIG. 9J, if a project includes a Cable Set Top Box with Alias “Yes1” located in the Main Bedroom providing “Muting” functionality, the Automatic GUI generation process may provide the action “Do “MUTE” on “Yes1” in Main Bedroom, automatically using the standard command “MUTE”. The user then may modify the action according to his/her personal needs.

A callback handling mechanism is also preferably provided, allowing for evented-variables to be displayed and/or processed by the Interface screen at run-time. For example, if a project includes a thermostat, the temperature will be the evented variable. The user will be able to see the changing temperature via the user interface in real-time.

An evented-variable may be of type string, range (integer), or allowed-value. If the selected evented variable is of type string or range, the actual value is returned. If the selected evented variable is of type Allowed-value, the user settings will determine alternative data for each possible allowed-value. The mapped replacement data will be associated with the target selection determined above but can be data other than text. For example, if the template defines a change to the icon of a button, the replacement value can be a path to an image file.

The notification processing is preferably handled via a screen builder module. Several objects can receive and manage notifications on evented-variables received from the control point, including Window, Button, Image, and Label objects. All objects preferably employ the same mechanism for processing notifications, but differ in the actions that can be executed when specific conditions are met.

Referring again to FIG. 9B, the GUI generation process may be understood as follows. Each control box preferably links to a higher-level list of other control boxes, referred to as “global main,” which enables the user to access and control the other control boxes in that local project. Each control box also preferably maintains a “private main” list which enables it to access and control devices attached to it. The “global main” list and all the files linked to it is typically the same on all control boxes. If a zone or a control box is added to the project, the “global main” is preferably updated and distributed to all the control boxes.

A project-level GUI, referred to as “net main,” is preferably automatically generated. The template of the “net main” interface preferably includes a main file that has two types of buttons: a “home” button that leads to a screen or page which lists all the zones in the home automation project, and “zone” buttons, the pressing of any of which leads to a file that shows a button for each device as well as all the shortcuts to UPnP™ Subdevices belonging to Subsystems. Subdevices such as dimmers and switches are elements of a Subsystem such as a Lighting Control Systems or HVAC systems. Subdevices depend on the Subsystem and may be physically located throughout the installation environment. The Subsystem manages and controls the subdevices and is typically installed and wired by custom installer and electricians. The subsystem typically interfaces with a hardware controller such as a control box via a serial interface allowing a system based on the present invention to control the subsystem which in turn controls the subdevices.

GUIs are also preferably automatically generated for all defined zones by looping through all defined devices and creating for each device a button based on the properties and defined in the template for the control box GUI screens. For example, the “onCommand” attribute of the button which holds the action command for the GUI object will, when clicked by the user, open the GUI of the requested device. This is achieved by preprocessing the address list of the existing devices, creating a button, and assigning the UPnP™ device address which manages the device to that button's “onCommand” event.

GUIs are also preferably automatically generated for all defined devices by searching for an XML definition having the same name of the device and extracting the device type name from it (e.g., a Sony wide screen TV model “xyz” is of type “TV”). Then, the templates folder, such as is shown in FIG. 9K, is searched for the specific device. If found, the corresponding template is retrieved. Otherwise, a template for a generic device type is used. In cases where neither has been defined, a general template may be used.

Using the device name, the corresponding Device Command File is retrieved and parsed to create a device command list. For IR devices, this file preferably corresponds to the LIRC format (i.e., open-source project). For all other devices using other connection and communication methods (e.g., serial protocol), a device command file using a proprietary format may be used. Device command files preferably include predefined standardized device commands so that commands extracted from the template will have corresponding commands in the template file.

Once the files have been parsed, the buttons in the template are compared to the commands list extracted from the device command file. Any buttons that exist in the template but do not have a counterpart in the device command list may be left without an “onCommand” action assignment.

In the GUI file, each standardized button preferably has a unique ID identical to the standardized name. The generic function executed when the user presses the button sends the standardized command name as a parameter to the system, thus closing the loop between the GUI and the execution request on the device.

The screen builder preferably does not limit the user to the automatically generated GUI. The user may, at any time, modify each screen, both visually and functionally, or create a new screen. A new screen can be designed to control any number of devices in the project. When modifying or creating a new screen, the user can decide on the overall design of the screen, such as by changing the background, adding buttons, inserting images and assigning events to new items on the screen.

Notification actions may be assigned to any of the screen builder objects via a “Notification” tab associated with the respective object, such as is shown in FIG. 9L. The basic building block of device notifications is the task. A screen builder object may execute one or more tasks when certain events on the home network occur that meet the set conditions of the task.

Each task may contain one or more conditions tested against an evented-variable belonging to a specific device on the network. If the conditions are met, selected actions are executed.

The user may do the following:
Add a new task, such as by pressing the green “Plus” icon or double-clicking an empty row as is shown in FIG. 9M.
Edit an existing task by double-clicking the task name to open a Conditions Management dialog such as is shown in FIG. 9N
Delete a task by selecting the task name and pressing the red “x” icon
Arrange task sequence by pressing the blue “Up” or “Down” arrows

A task condition enables the user to link a device event to the task to be executed on a specific screen builder object. The user may:
Add a new Condition by pressing the green “Plus” icon or double-clicking and empty row. This will open a Device Condition selection dialog, such as is shown in FIGS. 9O and 9P, depending on the Device Type.
Edit an existing Condition by double-clicking the condition name to open the conditions Management dialog, such as is shown in FIG. 9P.
Delete a Condition by selecting the task name and pressing the red “x” icon
Arrange the Condition sequence by pressing the blue “Up” or “Down” arrows

The task condition is preferably linked to a specific device on the home network. The condition and possible values are preferably determined (i.e., retrieved from the device XML specification) as soon as the device from which notifications are to be received has been selected. The available options may depend on the selected device type and its connection type. Thus, some devices may offer a specific list of possible events, while others may provide a possible range of numerical values, such as is shown by way of example in FIGS. 9Q-9S.

When all specified conditions have been met, one or more actions may be executed. The user may:
Add a new Action, such as by pressing the green “Plus” icon or double-clicking and empty row in FIG. 9M. This will open the Device Condition selection dialog as displayed in FIGS. 9O and 9P, depending on the Device Type.
Edit an existing Action by double-clicking the condition name to open the conditions Management dialog as seen in 9P.
Delete an Action by selecting the task name and pressing the red “x” icon
Arrange an Action sequence by pressing the blue “Up” or “Down” arrows

The available actions may vary with the GUI object (i.e., Label, Button, Image, or Window) as described below. Depending on the action selected, an appropriate dialog will open to allow the required parameters to be set.

The following table summarizes actions that may be executed on a GUI object when a notification task occurs (e.g., when a button is to be processed when a notification occurs, the user may change the button image, change the border color, the background color, etc.).

| Buttons | Label | Image | Window |
|---|---|---|---|
| Change Image | Change | Change Image | Disable Buttons on |
| | Background | | Screen |
| | Color | | |
| Change Border | Change | | Change Background |
| Color | Text Color | | Image |
| Change Background | Change Text | | Change Background |
| Color | | | Color |
| Change Text Color | | | Change Text on a |
| | | | Button |
| Change Button State | | | Change Text on a |
| (All Three States) | | | Label |
| Change Text | | | Switch Frame |

The automatic GUI generation preferably merges templates with the relevant device functionality. The templates used may be created and/or modified using the same mechanism employed for device interfaces. Once a template has been created according to the user's requirements, it may be saved to the “templates folder” according to its application.

An automation manager, such as is shown in FIG. 9T, is preferably provided for managing automation tasks. The automation manager may be implemented by an automation server that may be assigned to any control box, mini control box, touch controller, or connected PC. The automation manager preferably records tasks by Task Name, Description, Category (e.g., Security, Vacation, Automation), Status (e.g., Active/Disabled), and Task Type (e.g., indicating recurring task, time-based task, or mix of time+UPnP™ event).

A task in the automation manager may be edited in a task editor showing the contents, time conditions, and actions of the task for modification. The task editor may be used to view/edit the association of actions with one or more event or date/time triggers. The task editor GUI also preferably provides date/time and re-occurrences management. Task conditions may be related to evented variables. The task editor preferably provides the following:
a. Property management (containing General Task Info)
   i. Task ID (Non-editable)
   ii. Name (Editable)
   iii. Creation Date (Non-editable)
   iv. Description (Editable)
   v. Category (Editable)
   vi. Status (Editable)
   vii. Next Time (Non-editable)
b. Scheduling & Recurrence management
c. Condition management
   Provides the entry point for establishing a condition list to be associated with the action list of the task. Preferably lists all conditions.
d. Actions:
   Provides the entry point to establishing an action list to be associated with the time and/or event-based conditions of the task. Preferably lists all actions.
      i. Icon identifies the action type (UPnP™, JavaScript™, etc.)
      ii. Action list can be saved as macro (e.g., to disk)
      iii. Macro may contain other macros
      iv. Macros may contain Windows™ commands, Scripts, and UPnP™ commands

When modifications are made to automation tasks, the modifications are preferably synchronized with all automation lists maintained anywhere within the system.

An interface screen is provided for users to interact and control with the system. The interfaces are preferably web-based and are accessible via a browser which is run on any control box, such as using connected television screens as displays, touch panels, PCs, and handheld devices such as PDAs. The interface resources are preferably stored on control boxes or other suitable system elements and are served on request by an embedded web server.

The interface screens may be customized regarding their visual appearance and functionality of GUI elements. Additionally, an automatic GUI generation mechanism allows end-users to quickly create fully functional GUIs.

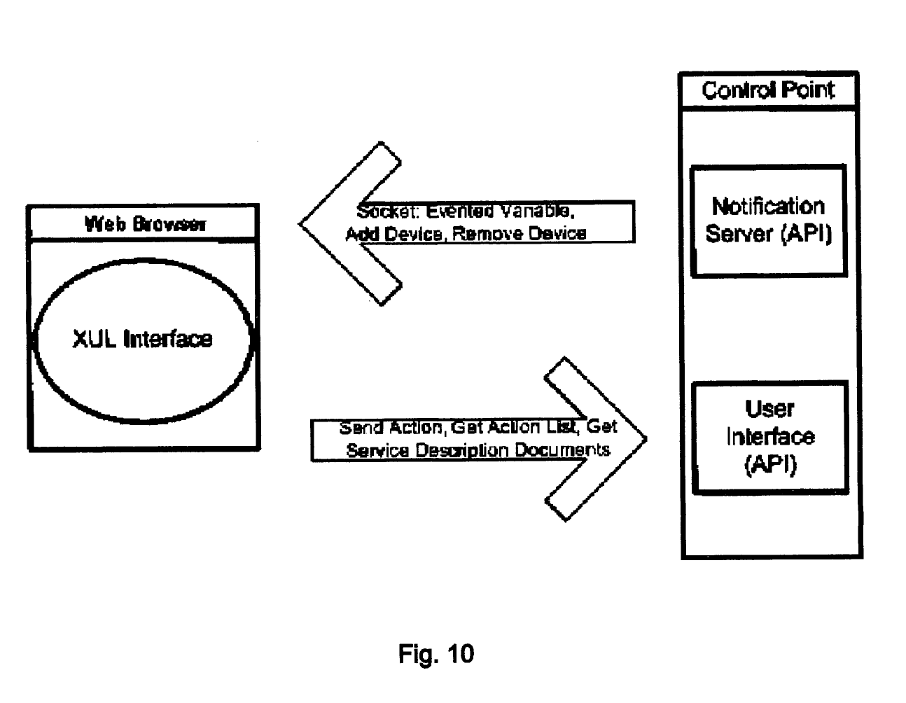

As shown in FIG. 10, UPnP™ commands are sent from the user interface screen to a control point for processing. The architectural design of the present invention preferably separates the user interface screen elements from the underlying backend functionality, such as the control point. Therefore, the interface screen technology can be replaced at any time without affecting the system architecture.

The user interface screen preferably employs XUL (XML-based User-interface Language) or HTML, as with PDA's and the Microsoft Windows™ Media Center™, and JavaScript™ to communicate with a control point. XUL is an application of XML used to describe window layout in the Netscape Mozilla™ browser. Where the embedded OS is Linux based, a version of the Netscape/Mozilla™ web browser (i.e., Firefox™) is preferably employed, being designed to support open Internet standards such as HTML 4.0, CSS, XML, RDF, XUL, and JavaScript™.

The user interface is typically defined as three discrete sets of components:
1. Content: This typically declares windows and user interface elements associated with them.
2. Skin: Contains style sheets and images to define the appearance of an application.
3. Locale: Displayable text within an application is partitioned and stored within locale specific files for easy language portability.

An infrared remote control may be used to control the web-based UI on the television connected to the control box. The remote control preferably includes functionality that allows the user to execute specific operations on the hardware, such as zooming in or out on a picture or movie, streaming media across the home network, or operating devices connected to the network.

In addition, several buttons on the remote control may be programmed to run UPnP™ actions according to the user's requirements. For example, the Power button may be programmed to execute a series of commands that will turn on a television, switch to A/V mode, turn on the receiver, and switch the cable box to a specific channel.

To configure a remote control for use with a particular control box, the control box object is preferably accessed as described hereinabove, and a remote control properties window is accessed. Remote control buttons may then be selected and configured. Similar to the event assignment of a screen builder object, UPnP™ events may be assigned to a specific command on the remote control.

Using mobile or landline phones that are not web enabled, users can call their home that has been configured with the present invention and access the automation project by interacting with an Interactive Voice Response (IVR) menu. The menu for the IVR mechanism may be created and customized via a user interface using conventional methods.

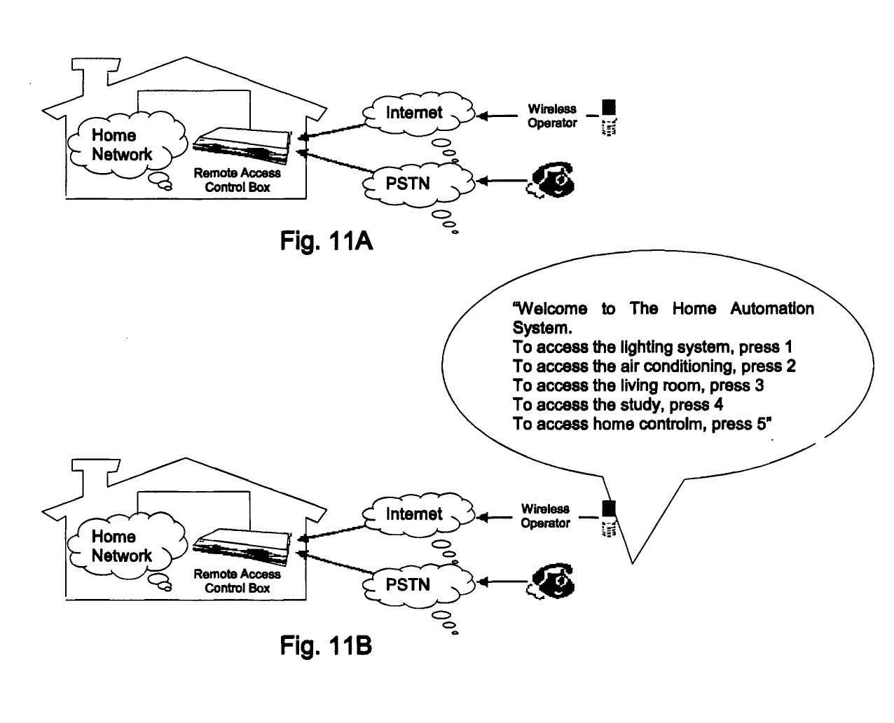

As shown in FIGS. 11A and 11B, a user can dial into a remote access control box using two alternative methods:
1. Regular landline phone using a PSTN network, In this scenario the remote access control box is connected to the PSTN via a standard modem,
2. Mobile phone using any Wireless Operator. In this scenario the user accesses the remote access control box via WAP or GPRS capable mobile phones operating on 2.5G or 3G network technologies.

Once connected, the remote access control box preferably authenticates the caller and presents him/her with the IVR menu. The user may listen to the menu options and execute various home automation functions by pressing the buttons on the keypad. Additional services such as user authentication, voicemail retrieval, SMS or voicemail to email may also be provided.

The present invention provides an IP-based platform that facilitates its integration with other IP-based services such as web page browsing, using the integrated web browser, and Voice over IP (VoIP). Some ways in which the present invention may be integrated with VoIP include:
Integration of messaging into system interfaces.
Using interface devices to interact with Unified Messaging or VoIP systems for message retrieval.
Providing video conferencing.
Integration of home appliances with telephony. For example, when an incoming VoIP call is detected, the stereo system may be muted or play a specific sound file.

A media manager application is provided to function as front-end to the media server described hereinabove with reference to FIG. 2A. The media manager is preferably implemented using XUL, HTML, and JavaScript™ and manages media files available on the network.

The media manager application is preferably designed to allow users to view their media folders and locations and decide which of them to make accessible to the home network. The media files available to the media manager include folders and system-supported media files. The user may navigate through any of the folders and subfolders, if any, available to the home network. Selecting a file in the folder view pane will preferably cause the file's properties to be displayed in a file information pane.

One or more virtual directories may be provided as follows. From the end-user's perspective, the virtual directory may appear as a folder containing media which will be accessible to a media controller or other media processing devices on the network. The media controller is provided to function as front-end to the various media servers available on the network. Contrary to the media manager, the media controller is intended to allow users to access specific media files on the network and stream them to a desired media renderer available on the network. The media controller is preferably implemented using XUL, HTML, and JavaScript™ and is available on all standard display types. The virtual directory may be created without changing the original location of the media file on the user's hard drive. The media server is responsible for maintaining the available virtual directories, preferably including a history of previously used virtual directories. A user may, at any time after the installation, add directories browsing to a folder and adding it to the Virtual Directory list, or remove directories therefrom. By default all directories below this “root” directory may be accessible unless this feature has been disabled through preference settings. Default folders may be established that cannot be removed from the virtual directory list.

The user may scan the system for existing supported media types at any time. This process collects information on all supported media files stored on connected devices and makes them available on the network. Once media files appear in a virtual directory tree view, their availability on the network can be managed using the add/remove feature described above. Scanning may be performed when the media server is initially installed. At the beginning of the scanning process, a tree of the file system about to be scanned is generated. Virtual directories may be added to the media server based on user selections

The user may filter media files based on file size as well (e.g., excluding files smaller than 1 MB). The applied selection and filtering may be saved for use during future scans. New files and folders which are children of active virtual folder may be added and made available to the network automatically as soon as they become available.

At run-time, automatic scanning is performed only on existing virtual directories. Manual scanning may be performed on any hard drive/folder on an attached computer. Virtual directories may be added as desired.

As was described hereinabove, a UPnP™ device is a container of services and nested devices defining the different categories of UPnP™ devices. An XML device description document hosted by the device maintains all device metadata including information about the embedded services and device properties (e.g., device name). The UPnP™ device implementation of the present invention is preferably cross-platform code running on top of the Intel™ UPnP™ SDK on Linux and Windows™. It is preferably used for all UPnP™ device implementations of the present invention and provides the basic UPnP™ device functionalities. In order to provide connection to non-UPnP™ enabled devices, UPnP™ bridge devices may be implemented for several interface types. UPnP™ software include the media server (FIG. 2A) and the media renderer (FIG. 1), while UPnP™ device bridges may be defined for IR, serial, and subsystem devices (e.g., lighting, X10), and USB device bridges.

The UPnP™ IR device of the present invention acts a bridge between the UPnP™ network and the IR transmission interface may be implemented via the LIRC Open-Source project and embedded in the ControlOS within the hardware. Alternatively, the LIRC Open-Source project may be hosted on a PC attached to the device control network. An important part of LIRC is the lircd daemon that decodes IR signals received by the lirc device drivers and provides the information to a socket. The UPnP™ IR device may be configured to run under Linux, and can preferably be configured to run on different ports depending on the hardware. The UPnP™ IR device preferably contains a single service defined as:

```
<service>
    <serviceType>urn:schemas-upnp-org:service:IRCONTROL:1
    </serviceType>
</service>
```

Among the various elements and attributes that may be defined in a description document for the UPnP™ IR device, <lircRemoteName/> is preferably used to communicate with the LIRC daemon with the appropriate remote name. Therefore, any UPnP™ command exposed by this service will automatically be sent to the LIRC daemon identified by the configured remote name.

The UPnP™ serial device of the present invention acts as a bridge between the UPnP™ network and the serial transmission interface implemented and embedded in the ControlOS within the hardware. The serial device description XML document template preferably contains a single service defined as:

```
<service>
    <serviceType>urn:schemas-upnp-org:service:SERIALCONTROL:1
    </serviceType>
</service>
```

The Serial Device Template functions as an adapter between a UPnP™ based TCP/IP network and the serial protocol. It contains a translation of all the device-specific communication settings and parameters in a well-formed XML based interface file. This solution requires no coding or compilation, and the driver may be modified and maintained within any text editor. All information about a specific serial device may be extracted from the manufacturer supplied manual or serial device description document.

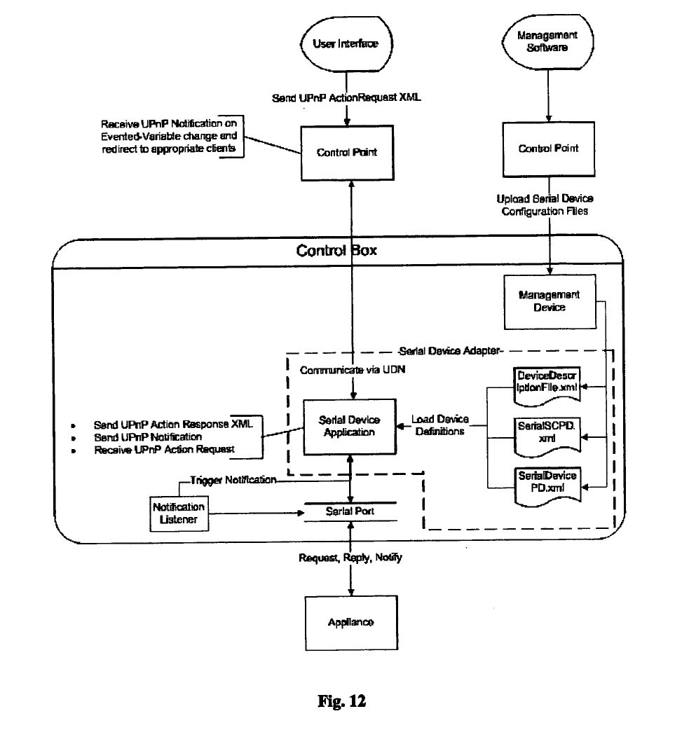

As shown in FIG. 12, the communication process with a serial device is initiated by a user requesting an action to be executed by the appliance. For example, a user may choose to press the Volume Up button on a User Screen. A UPnP™ Action Request is sent to the Control Point and then directed to the Serial Device Application identified by its Unique Device Name (UDN).

The Serial Device Application within the Serial Device Adapter receives the UPnP™ Action Request, and translates it to a serial command by retrieving the appropriate data from an in-memory representation of the user created Serial Protocol Definition file (SerialDevicePD.xml). The serial command is then directed to the serial port to which the device has been connected and configured. The serial device receives the serial command and performs the requested action. If the serial device returns a response to the serial device application, an appropriate UPnP™ Action Response is generated and is sent back to the control point to be redirected to the User Interface screen.

A serial device may send a response independent of a UPnP™ Action Request. For example, the user may operate the device directly, thus triggering a response to be sent to the serial device application. The Notification Listener will catch the serial response command and send a UPnP™ Notification to the Control Point if the Serial Protocol Definition contains a relevant evented Variable entry.

The Serial Protocol Definition may include:
Serial Type: Defines the communication protocol to be used. Possible Values: RS232, RS485 or RS422.
Baud Rate: Defines the Hardware speed. Possible Values: 300, 600, 1200, 1800, 2400, 3600, 4800, 7200, 9600, 14400, 19200, 28800, 38400, 57600, 115200.
Stop Bits: The last part of a character frame. Possible Values: 1, 2.
Parity: An optional parity bit that follows the data bits in the character frame. Possible Values: none, odd, even.
Data Bits: The number of data bits in a byte. Possible Values: 5, 6, 7, 8.
Desc: Device description.
Flow Control: Data transmission flow control. Possible Values: none, xon-xoff, hardware.
Carriage return: (Optional) If the device requires a CR at the end of the data transmission. Possible Values: Yes, No (Default).
Global delay: (Optional) The delay time in milliseconds between transmissions.

The user can override the global definition by placing a delay tag. (default: 0).

Some devices use values or characters that cannot be written to the output buffer. An optional TransTable may be provided that manages the conversion between forbidden values and their corresponding conversion values. This tag can be left empty if no conversion is required. Otherwise, the user must specify the following five tags for each value: Value, valueType, In, Out, Place.
Value: This tag represents the forbidden value.
valueType: Specifies the type of the received (or sent) value. Possible Values: numhex, numdec, string.
In: The forbidden value itself.
Out: The converted value.
Place: Which part of the input/output buffer should be checked for conversion.
   Possible values include:

A—the entire buffer except the start and end string.

ES—includes the end string.

SS—includes the start string.

A protocol defining the serial communication type/method may include:
Type: Communication type of the protocol: Possible Values: text, hex.
StartString: (Optional) This string will be attached to the start of every output buffer and be removed from the beginning of any input buffer. The user may also specify the data type attribute as well as the ByteSize of the StartString, example: <StartString ValueType=“numhex” ByteSize=“2”>0202</StartString>. ValueType can be: numhex, numdec and string. The default is string.
EndString: (Optional) This string will be attached to the end of every output buffer and be removed from the end of any input buffer. The user may also specify the data type attribute as well as the ByteSize of the EndString, Possible Values: numhex, numdec and string (default).
Sequence: Some of the serial devices require that a session be opened and closed before and after a command is sent, respectively. This part describes the StartSequence and the EndSequence. The ValueType is extracted from the protocol type.
StartSequence: (Optional)
   Request: (Optional): A string that opens the session.
   Reply: (Optional): An expected reply to the StartSequence request.
EndSequence: (Optional)
   Request: (Optional): A string that closes the session.
   Reply: (Optional): An expected reply to the EndSequence request.
CheckSum: (Optional) Some serial devices require a checksum field in the output buffer. This part describes this field: the way it's constructed, byte size of the field and where it is placed. Possible Values: SS, A, ES, Size. If the user implements a checksum, all fields are mandatory.
   SS—Include the StartString in the checksum calculation.
   A—Include the data part of the buffer in the checksum calculation.
   ES—Include the EndString in the checksum calculation.
   SIZE—Include the size of the whole output buffer in the checksum calculation.
   Last—the checksum will be placed at the end of the buffer.
   BL—the checksum will be placed before the EndString. If none exists, it will be placed at the end.
   Place: The location of the checksum field. Possible Values: Last, BL (Before Last).
   ByteSize: The ByteSize length of the checksum field.

A UPnP™ device supports one or more actions which may be invoked. An action list is preferably provided that contains all actions supported by the UPnP™ serial device, their arguments and the format of the command. Any input parameters are preferably associated with relatedStateVariable. If there are no parameters in the command (which implies that the command is a simple string), no related state variable needs to be specified.
Name: The name of the action.
Delay: (Optional) The number of milliseconds to wait after sending a command. If this parameter is specified, it overrides the globalDelay parameter. Otherwise, the globalDelay parameter determines the delay for all of the commands.
Seq: This field defines whether a session must be opened to send the command and closed afterwards.
Request: Describes the format of the requested action output buffer.
Reply: (Optional) Describes the format of the reply action input buffer.
argumentList: The argument list can contain several arguments each of which contains the following fields:
   name: The name of the argument.
   direction: Is the argument part of the output buffer (that means, part of the command that will be sent to the actual device) or is part of the reply buffer (that means, part of the reply that we will get from the actual device). Values: in, out.
   relatedStateVariable: Each of the arguments must be associated with one related state variable. Here we specify the name of the related state variable.

A service state table is preferably provided that is used to send notification messages about changes that occur within the serial device. Thus, the sendEvents attribute must be set and the following fields must be provided for each related state variable: name, dataType, valueType, and allowedValueRange/allowedValueList.
sendEvents: Specifies whether a notification should be sent if the value of the variable changed. Possible Values: yes, no.
name: the name of the variable.
dataType: The converted data type. Possible Values: string, numhex, numdec.
valueType: The actual data type received from the serial device. Possible Values: numhex, numdec and string.
allowedValueRange/allowedValueList: This tag specifies the allowed values for this variable, which can be ranged or limited to several values.
a) PTValue: (Optional)
   This attribute defines the actual value that the serial device should receive and return. If this attribute does not exist, no conversion will occur.
b) allowedValueRange: This element defines the user specified minimum and maximum allowed values. In the example below, a related state variable supports a maximum value of +30 and minimum value of −30. The actual sent and return values, however, are 0x62 and 0x9E. Therefore, the UPnPSerialDevice must exercise a conversion in both directions. For example:

```
  <allowedValueRange>
    <minimum PTValue=“62”>−30</minimum>
    <maximum PTValue=“9E”>+30</maximum>
</allowedValueRange>
```

c) allowedValueList: This element defines the user specified list of all allowed values. In the example below, a related state variable's supported values are 0, 1, 2, 4, 6, 8 which will be converted in both directions according to the values in the tag. For example:

```
  <allowedValueList>
    <allowedValue PTValue=“0”>NTSC</allowedValue>
    <allowedValue PTValue=“1”>PAL60</allowedValue>
    <allowedValue PTValue=“2”>4.43NTSC</allowedValue>
    <allowedValue PTValue=“4”>PAL</allowedValue>
    <allowedValue PTValue=“6”>SECAM</allowedValue>
    <allowedValue PTValue=“8”>Auto</allowedValue>
</allowedValueList>
```

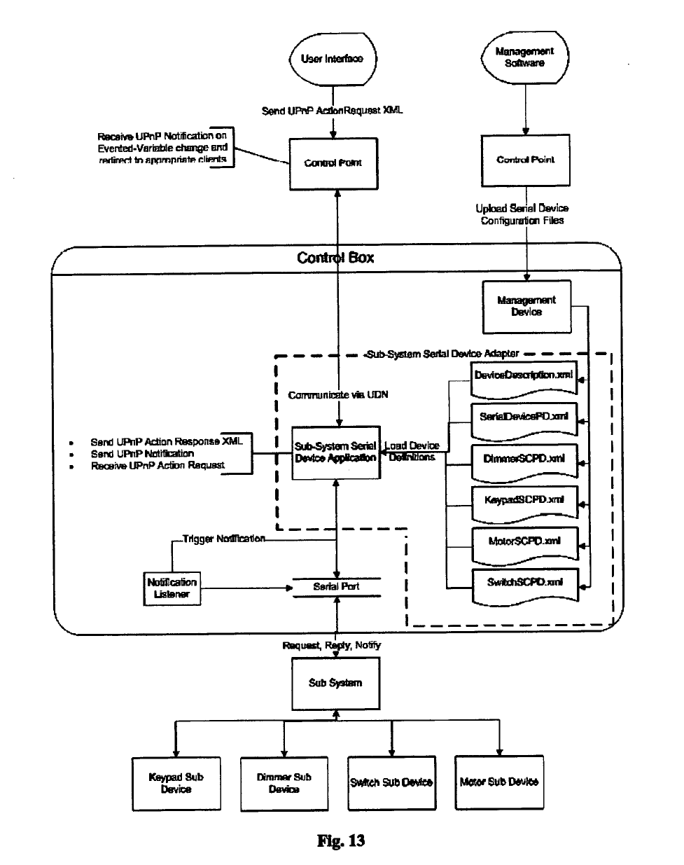

In FIG. 13 a Subsystem device is shown acting as a bridge between the UPnP™ network and the serial transmission interface implemented in the ControlOS within the hardware in a manner similar to the serial device interface. It is preferably designed to allow integration of third-party subsystems such as lighting or HVAC systems which generally manage and control their subappliances using standard or proprietary protocols. In the present invention, the main difference between UPnP™ serial devices and UPnP™ subsystems is reflected in the management and control of subappliances within the Subsystem. Although subsystems manage and control numerous subappliances, only one instance of the subsystem serial device exists per physical subsystem, containing one instance of a service description per subappliance type (i.e. keypad, switch, dimmer, motor, etc). Each service description file maintains one evented-variable assigned to each subappliance. Communication from the Subsystem Serial Device Adapter to the physical subappliance is therefore executed by requesting the Subsystem to control its subappliance

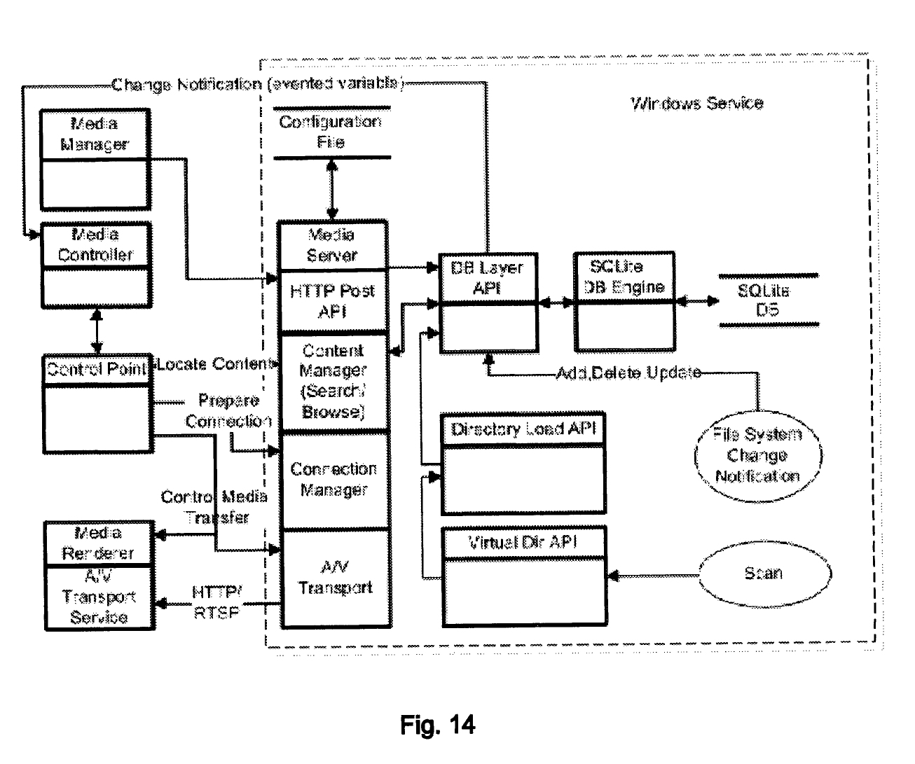

Reference is now made to FIG. 14, which is a simplified block diagram of a media server architecture, constructed and operative in accordance with a preferred embodiment of the present invention. In FIG. 14 the UPnP™ media server of the present invention is preferably based on the UPnP™ Media Server Device Template requiring that each implementation of the Media Server include a Content Directory and Connection Manager Service. The Content Directory service allows Control Points to discover information about the AV content that is available from the device. The Connection Manager is used to select a particular transfer protocol and data format to be used for transferring the content. The existence of the AVTransport service depends on the transfer protocols that are supported by the device.

UPnP™ Media Server devices are used in conjunction with one or more Media Renderer device(s) to allow a Control Point to discover entertainment (AV) content (e.g. video, music, images, etc) on the Media Server and to render that content on any appropriate Media Renderer within the home network. In general terms, the process begins with the Control Points discovering Media Server and Media Renderer devices within the home network. The Control Point interacts with a Media Server(s) to locate a desired piece of content (e.g., a movie, a song, a play list, a photo album, etc). After the content has been identified, the control point needs to identify a common transfer protocol and data format that can be used to transfer the content from the Media Server to the desired Media Renderer. After these transfer parameters have been established, the Control Point controls the flow of the content (e.g. Play, Pause, Stop, Seek, etc.). Depending on the selected transfer protocol, these flow control operations are preferably sent either to the Media Server or the Media Renderer, but not both. The actual transfer of the content is performed directly by the Media Server and Media Renderer using a transfer protocol other than UPnP.

The Media Server is preferably implemented as a Windows™ Service and contains the following components and functionality:
HTTP Post API: Interface for Media Management GUI which interacts with the Database Layer to maintain and retrieve data from the Media Database. The interface provides management and access to the virtual directories, play lists, and media files via UPnP™ Browse and Search actions.
Database Layer API: Provides SQL query interfaces to be run against the Slate database.
SQLite Open Source Database: Contains tables holding meta-data about the Media Server database as well as information on all media files available to the home network. The Media Server database maintains the following information on media files: File ID, Full Path, Virtual Directory, Title, Creator, Artist, Album, Genre, Comments, Copyright, Format, Track Number, Year, Bit rate, Time Length, Size, Type, Parented, Child Count, Frequency
File System Change Notification: Real-time monitoring of file system changes (mapped via Virtual Directories) to keep the database up-to-date and provide access to “change information” to Media Controller/Manager via evented variables.
Configuration File: Contains data on default system virtual directories, supported Media Types and transfer protocols to be used, as well as logging and networking settings.
Directory Load Management API
Virtual Directory API
Media Scan mechanism

The UPnP™ Media Renderer of the present invention is preferably based on the UPnP™ Media Renderer Device Template running on the Linux platform.

A UPnP™ control point is provided that is a controller capable of discovering and controlling other devices on a network. After discovery, a control point can retrieve the device description and its services, invoke actions to control a service, and subscribe to the service's event source. Anytime the state of the service changes, the event server will send an event to the control point. The specifications are defined and managed by the UPnP™ forum and are described in the UPnP™ Device Architecture document.

The control point is preferably cross platform code that runs on top of the Intel™ UPnP™ SDK, running under Linux, Windows™ and WinCE™, as a Windows™ service and/or a Linux daemon.

The Control Point configuration file is preferably loaded from a ControlPointConfig.xml Configuration file located on Windows™ at /INSTALL_DIR/CP/ServerRoot/, and in Linux at /etc/upnp/CP/ServerRoot/ControlPointConfig.xml. Using this configuration file, the Control Point's Networking parameters, device search types, and logging level may be configured and UPnP™ devices and services may be filtered.

There are two interfaces for applications to interact with the control point.
1. Commands—Clients can send different commands to the control point, such as send UPnP™ action, get variable state, etc., via a HTTP POST to its built-in Web server.
2. Notification—The application can register to receive event notification for UPnP™ events, new devices, and removed devices. The control point has a notification server that accepts connections of client's sockets over the TCP/IP Network. When a new client is connected and opens a socket (which is alive for the whole session), the server registers it as subscriber for events. When the Control Point sends an event (as a result of status change, or a change of a value in the evented variables), the Notification Server sends it to the open sockets of all the clients.

A command interface is provided that is accessible through a post command to the control point http server, being a localhost with a port number specified in the configuration file <uiHttpPort>.

The available commands may include:
1. GetList: Retrieves the list of devices available on the network. Parameters provide for filtering by Type or UDN.
2. UpnpAction: Send any UPnP™ action to a specific device.
3. GetServiceDescDoc: Retrieves the service description document for a specific UDN and serviceID.
4. GetVar: Get the variable for a specific UDN and service ID.
5. GetUri: Get URI for UDN.
6. RegisterEventedVar: Register for a specific event variable that you want to receive notification for. The default settings send all notifications.
7. UnRegisterEventedVar: UnRegister a event variable for which notification was selected.
8. GetUriMap: More detailed UDN uri mapping
9. RegisterLocalUdn: Register local Uri for UDN for the preview functionality.
10. UnRegisterLocalUdn: UnRegister local Uri for UDN for the preview functionality.

Notification is preferably provided via a TCP port on the local host, with the port number being specified in the configuration file <cpNotificationsPort>.

The available notifications may include:

### 1. Add-device

When the control point receives notification that a new UPnP™ device was added to the UPnP™ network it will send a notification to all subscribers.

### 2. Remove-device

When a UPnP™ device sends a notification message that it is about to exit the UPnP™ network, the control point will notify all subscribers to remove the UPnP™ device from their list.

### 3. Variable-changed

When the control point receives an evented variable change notification, it will send the variable and its new value to all subscribers.

An IR Learning application is preferably provided which allows new remote control configurations to be learned and existing remote control configurations to be edited. The application preferably includes a wizard to quickly capture and verify IR codes in order to expand the system's database of remote controls. The learning/editing process of a remote control is handled by the IR receiver/transmitter embedded in the control box.

The XML-based serial adapter described hereinabove may be created by using a wizard-based Serial Adapter Creator, where all required information about a specific device can be extracted from the manufacturer supplied user manual or serial protocol definition document. The generated driver may then be added to the system device driver database. The generic design of the serial device template allows an end-user to easily create a device specific interface to enable a non-UPnP™ enabled device to be integrated into the home automation system.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A networked device control system comprising:
a plurality of networked device controllers operative to implement a protocol of automatic device discovery and control;
at least one non-protocol-compliant device connected to any of said controllers and not configured for use with said protocol prior to being connected to said controller; and
a management unit operative to
generate any of an interface and a control element associated with any of said devices,
establish a proxy configured for use with said protocol and operative to control said non-protocol-compliant device, and
configure any of said controllers with said interface and control element generated for said device connected to said controller.

2. A system according to claim 1 wherein said management unit is operative to configure any of said controllers to which said non-protocol-compliant device is attached to act as said proxy.

3. A system according to claim 1 wherein said proxy is operative to:
translate a protocol-compliant command into a command for controlling said non-protocol-compliant device; and
send said translated command to said non-protocol-compliant device.

4. A system according to claim 1 wherein said protocol is the UPnP™ protocol.

5. A networked device control system comprising:
a plurality of networked device controllers operative to implement a protocol of automatic device discovery and control;
at least one protocol-compliant device connected to any of said controllers and configured for use with said protocol prior to being connected to said controller;
at least one non-protocol-compliant device connected to any of said controllers and not configured for use with said protocol prior to being connected to said controller; and
a management unit operative to
generate any of an interface and a control element associated with any of said devices,
establish a proxy configured for use with said protocol and operative to control said non-protocol-compliant device, and
configure any of said controllers with said interface and control element generated for said device connected to said controller.

6. A system according to claim 5 wherein said management unit is operative to configure any of said controllers to which said non-protocol-compliant device is attached to act as said proxy.

7. A system according to claim 5 wherein said proxy is operative to:
translate a protocol-compliant command into a command for controlling said non-protocol-compliant device; and
send said translated command to said non-protocol-compliant device.

8. A system according to claim 5 wherein said protocol is the UPnP™ protocol.

9. A method for networked device control, the method comprising:
deploying a plurality of networked device controllers operative to implement a protocol of automatic device discovery and control;
connecting at least one non-protocol-compliant device to any of said controllers and not configured for use with said protocol prior to being connected to said controller;
generating any of an interface and a control element associated with any of said devices;
establishing a proxy configured for use with said protocol and operative to control said non-protocol-compliant device; and
configuring any of said controllers with said interface and control element generated for said device connected to said controller.

10. A method according to claim 9 and further comprising configuring any of said controllers to which said non-protocol-compliant device is attached to act as said proxy.

11. A method according to claim 9 wherein said generating step comprises:
defining a non-protocol-compliant device type, including a command set, a communication protocol, and an interface; and
generating said proxy from said definition.

12. A method according to claim 9 and further comprising:
translating a protocol-compliant command into a command for controlling said non-protocol-compliant device; and
sending said translated command to said non-protocol-compliant device.

13. A method for networked device control, the method comprising:
deploying a plurality of networked device controllers operative to implement a protocol of automatic device discovery and control;
connecting at least one protocol-compliant device to any of said controllers and configured for use with said protocol prior to being connected to said controller;
connecting at least one non-protocol-compliant device to any of said controllers and not configured for use with said protocol prior to being connected to said controller;
generating any of an interface and a control element associated with any of said devices;
establishing a proxy configured for use with said protocol and operative to control said non-protocol-compliant device; and
configuring any of said controllers with said interface and control element generated for said device connected to said controller.

14. A method according to claim 13 and further comprising configuring any of said controllers to which said non-protocol-compliant device is attached to act as said proxy.

15. A method according to claim 13 wherein said generating step comprises:
defining a non-protocol-compliant device type, including a command set, a communication protocol, and an interface; and
generating said proxy from said definition.

16. A method according to claim 13 and further comprising:
translating a protocol-compliant command into a command for controlling said non-protocol-compliant device; and
sending said translated command to said non-protocol-compliant device.

17. A method for communicating UPnP™ commands to a non-UPnP™-compliant device, the method comprising:
converting a control specification of a non-UPnP™-compliant device into a mapping between at least one non-UPnP™ command and at least one UPnP™ command;
creating an instance of a UPnP™ device to receive UPnP™ commands and output a corresponding command to said non-UPnP™-compliant device;
looking up a UPnP™ command in said mapping; and
sending a corresponding command to said non-UPnP™-compliant device.

18. A method according to claim 17 wherein said control specification is that of any of a serial, IR, relay, I/O, or USB device.

19. A method according to claim 17 wherein said converting step comprises converting into an xml-based format.

20. A method according to claim 17 and further comprising:
receiving a command from said non-UPnP™-compliant device;
looking up a UPnP™ command in said mapping corresponding to said received command; and
sending said UPnP™ command to a UPnP™ controller.

21. A method according to claim 17 wherein said creating step comprises creating said UPnP™ device for a subsystem to which multiple sub-appliances are connected, said UPnP™ device having one UPnP™ service for each sub-appliance type, and each of said UPnP™ services having separate references for each of said sub-appliances.

22. A method according to claim 21 and further comprising:
translating a UPnP™ command into a command;
sending said command to said subsystem together with an identifier of any of said subappliances to which said command is directed.

23. A method according to claim 17, and further comprising:
automatically assigning an interface element with any of said commands; and
upon said interface element being activated, performing said lookup and sending steps with respect to said command associated with said interface element.
